(19) United States
(12) Patent Application Publication
(10) Pub. No.: US 2008/0318144 A1
(43) Pub. Date: Dec. 25, 2008

(54) TONER, DEVELOPER, AND IMAGE FORMING METHOD

(76) Inventors: Naohiro Watanabe, Sunto-gun (JP); Shinichi Wakamatsu, Numazu-shi (JP); Hiroshi Yamashita, Numazu-shi (JP); Tsuyoshi Sugimoto, Mishima-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/143,244

(22) Filed: Jun. 20, 2008

(30) Foreign Application Priority Data
Jun. 22, 2007 (JP) 2007-165565
Dec. 19, 2007 (JP) 2007-327028

(51) Int. Cl. G03G 13/16; G03G 9/09

(52) U.S. Cl. 430/48; 430/108.21

(57) ABSTRACT

To provide a toner including: a toner material that contains at least a binder resin, a pigment, and a pigment dispersant, wherein the pigment dispersant has an acid value of 20 mgKOH/g to 50 mgKOH/g and an amine value of 1 mgKOH/g to 50 mgKOH/g, and wherein the pigment contains at least aluminum phthalocyanine.

### BACKGROUND OF THE INVENTION

1. Field of the Invention

The present invention relates to a toner for developing latent electrostatic images by electrophotography, electrostatic recording, electrostatic printing, etc., a developer and image forming method using the toner.

2. Description of the Related Art

In electrophotographic image forming apparatus, electrostatic recording apparatus, etc., electric or magnetic latent images are visualized by toner. In electrophotography, for example, a toner image is produced by forming an electrostatic image (latent image) on a photoconductor and developing the image by toner. The toner image is generally transferred onto a transfer material (e.g., paper) and fixed thereto by heating or the like. The toner used for development of latent electrostatic images is generally composed of colored particles prepared by adding a colorant, a charge control agent and additional additives in binder resin. The toner manufacturing methods are broadly classified into pulverization methods and suspension polymerization methods. In the pulverization method, a colorant, a charge control agent, an offset inhibitor and other agents are melt-kneaded with thermoplastic resin and homogenously dispersed, and the resultant composition is pulverized and classified to produce a toner.

The pulverization method can produce a toner with somewhat excellent characteristics, but the latitude is limited in the selection of toner materials. For example, the toner composition prepared by melt-kneading of toner materials needs to be capable of being pulverized and classified with economically available devices. This requirement necessitates that the melt-kneaded composition be sufficiently fragile. For this reason, when the toner composition is pulverized into particles, it becomes likely that a broad particle size distribution is produced, and therefore, in an attempt to produce a high-resolution copy image with many levels of gray, it is necessary to remove, for example, fine particles with a diameter of 5 μm or less, particularly 3 μm or less, as well as coarse particles with a diameter of 20 μm or more. This leads to very low toner yield. With the pulverization method, it is difficult to homogenously disperse such agents as a colorant and a charge control agent in thermoplastic resin. Moreover, with the pulverization method, the colorant component added in the toner is undesirably exposed to the toner surface and thereby the charge distribution becomes uneven over the toner surface, leading to a broader toner charge distribution and poor developing characteristics. Thus, the current situation is that kneading/pulverization methods cannot fully fulfill the requirements of producing high-performance toner owing to these problems.

In recent years, toner manufacturing methods using suspension polymerization have been suggested and put into practice as methods that can overcome the above-mentioned problems pertinent in pulverization methods. Production of toner by polymerization is a known technology; for example, current toner particles are produced by suspension polymerization. Toner particles produced by suspension polymerization, however, have substantially spherical shape and thus are hard to be removed. In the case of low-image coverage development and transferring, the amount of residual toner particles is small and thus cleaning failure is not significant. However, cleaning failure becomes significant in the case of development and transferring of a high image coverage object, such as a picture image. Moreover, toner particles that have been used for development but remained untransferred due to paper feed failure or the like reside on the photoconductor as residual toner particles and cause background smear when accumulated.

Such residual toner particles smear on, for example, a charging roller, a member which contacts and charge the photoconductor, preventing it from exerting its original charging ability. Moreover, since toner is manufactured at the same time resin is produced by suspension polymerization, it is often the case that toner materials used for conventional toners cannot be used in suspension polymerization. Even when polymerization is successfully effected using conventional materials, in some cases, the particle size cannot be fully controlled due to influences of resin and additives such as colorant. Thus, one of the problems associated with suspension polymerization is its limited latitude in the selection of materials, with the major problem being the fact that polyester resins, which offer excellent toner fixing property and coloring property when employed in conventional kneading/pulverization methods, cannot be generally employed and, therefore, this method cannot be used in view of growing demands for smaller, faster color printers. To overcome the problem pertinent in suspension polymerization, for example, Japanese Patent (JP-B) No. 2537503 discloses a method of producing randomly shaped toner particles by aggregating fine resin particles produced by emulsion polymerization. In the toner particles produced by emulsion polymerization, however, a large number of surfactant components remain not only on the toner surface, but inside the toner even after washing process, leading to poor toner charge stability and broader charge amount distribution, which in turn causes background smears on the obtained image. In addition, the remained surfactant smears on the photoconductor, charging roller, developing roller, and other members, preventing them from exerting their original charging ability. Even in the case of emulsion polymerization where the colorant components are hardly exposed to the toner surface, it is difficult to homogenously disperse colorant in the toner since colorant components are easily aggregated together. Because the manner in which colorant exists differs between individual toner particles, there are variations in charge amount among toner particles and thus toner stability over a long period decreases. In addition, in the case of color printing, slight reductions in developing ability and transfer ability leads to poor color balance and poor gray scale Furthermore, since the colorant in the toner particles is generally hydrophilic and is not compatible with resin, diffused reflection of transmitted light occurs at the interface of surfactant and resin components, reducing the transparency of OHP sheets and the like when printed. Namely, when the colorant is not sufficiently dispersed in the toner, the transparency of the printed OHP sheet reduces.

Japanese Patent Application Laid-Open (JP-A) No. 2001-66827 discloses a toner produced by the method including the steps of dissolving or dispersing in a first organic solvent capable of dissolving binder resin a pigment dispersant and a pigment that has been surface-treated with a fatty acid, to prepare a pigment dispersion solution, mixing a binder resin with the pigment dispersion solution in a second organic solvent capable of dissolving binder resin, to prepare an oil component, suspending the oil component in an aqueous medium to form microdroplets of the oil component, and removing the solvent from the suspension. However, fatty acids contain no amino groups that control toner charging ability.

JP-B No. 3661422 discloses a toner produced by using a polymer dispersant as a pigment dispersant. This disclosure specifies the acid value and amine value of the polymer dispersant so as to provide a toner that offers excellent offset resistance, charging ability, storage stability, color developing ability, and OHP transparency. However, storage stability, particularly resistance to “blocking” that occurs during toner delivery, are insufficient. In this disclosure, a synergist, a pigment derivative, is added as a pigment dispersing aid. This synergist can enhance pigment dispersibility by introducing polar groups into the pigment so as to increase its interactions with the pigment dispersant. However, when the synergist is used in the manufacture of so-called chemical toner, where toner is prepared in an aqueous system, it results in unwanted migration of pigment components toward toner surface or into the aqueous phase during toner manufacture. The causes of these phenomena still remain elusive. In general, synergists are considered to adsorb to surfaces of pigment components, where they introduce polar groups into the pigment so as to increase its interactions with a pigment dispersing aid. The polar groups of synergists are considered to be generally hydrophilic, suggesting that migration of pigment component toward toner surface or into the aqueous phase occurs during toner manufacture. These phenomena lead to reduced coloring ability and reduced color saturation, and/or poor fixing characteristics, and furthermore, leads to pigment smear on other members.

Currently, it is common to remove an oil supplier of the fixing device particularly from color printers and to use oil-less toner in which a releasing agent is added in place of oil. However, it is difficult to homogenously disperse a releasing agent in toner particles since particles of releasing agent cannot be reduced in size as can colorant particles. When the releasing agent is not sufficiently dispersed, it results in poor charging ability, developing ability, storage stability, and OHP transparency.

Copper phthalocyanine pigment is one type of pigments that have a brilliant blue color and excellent robustness, and has been used as one of three primary colors for process printing. Currently, pigments have been widely employed as colorants in various image recording methods, including electrophotographic recording, inkjet recording and thermal transfer recording, in addition to conventional printing methods that uses printing plates. In these printing methods there is a growing demand to replace copper phthalocyanine pigments, which show cyan color, with blue-green pigments or transparent, brilliant image recording agents using those pigments, for the purpose of achieving higher color reproducibility upon image formation. The ISO/Japan Color established jointly by the Japanese Society of Printing Science and Technology (JSPST), Japan Printing Machinery Association (JPMA) and Japanese Committee of ISO/TC130 is published (i.e., “JAPAN COLOR—Color Reproduction & Printing 2001” for sheet-fed offset printing; see the instruction manual published by JSPST and Japanese Committee of ISO/TC130), wherein colors using standard inks and standard papers are defined). It is generally difficult to reproduce cyan color on art paper, which exhibits widest color reproduction range among other standard papers, by use of copper phthalocyanine alone. Thus, copper phthalocyanine pigment is generally mixed with chlorinated copper phthalocyanine for use.

Blue-green pigments are generally prepared by mixing copper phthalocyanine pigments and chlorinated copper phthalocyanine pigments. JP-A No. 05-263006 discloses as an improved version of the above blue-green pigment a solid solution pigment (blue-green color) prepared using a high-chlorinated copper phthalocyanine pigment and a low-chlorinated copper phthalocyanine pigment. JP-A No. 09-68607 discloses a chlorinated copper phthalocyanine pigment (with blue-green color) in which the number of chlorine atoms attached to copper phthalocyanine is adjusted during synthesis of copper phthalocyanine.

However, since chlorinated copper phthalocyanine pigments contain chlorine atoms, they are not desirable in view of recent demands for halogen-free colorants. In addition, it is preferable not to use chlorinated copper phthalocyanine pigments since they contain trace amounts of Class 1 specified chemical substances—non-decomposable, persistent substances that are harmful to the environment and human body.

JP-A No. 2001-89682 discloses an example where the use of chlorinated copper phthalocyanine pigments is avoided by mixing copper phthalocyanine and aluminum phthalocyanine. When this mixed pigment is used as a colorant for toner for development of latent electrostatic images, the cyan color can be made blue-green. However, the pigment prepared by merely mixing two different pigments offers poor color saturation and produces a much narrower color reproduction range than that of pigment consisting only of copper phthalocyanine. Although this disclosure avoids reduction in color saturation by mixing copper phthalocyanine and aluminum phthalocyanine during pigment preparation, the resultant pigment still offers insufficient color reproduction range and insufficient coloring ability.

Thus, the current situation is that toner and other relevant technologies, which can meet the demand of high performance printers, have not yet been provided.

### BRIEF SUMMARY OF THE INVENTION

An object of the present invention is to provide: a toner that can reproduce cyan color on standard paper with fidelity, which cyan color as indicated on the ISO/Japan Color art paper specified in the Japanese Committee of ISO/TC130, that offers OHP transparency, a broad color reproduction range, and excellent offset resistance, charging ability and storage stability, that is not harmful to the environment and human body, and that can achieve high image quality on standard paper as compared to offset printing, by increasing the dispersibility of aluminum phthalocyanine, a compound that is less dispersed in toner, by employing a specific pigment dispersant, and by mixing it with copper phthalocyanine at specific proportions; and a developer and image forming method using the toner.

Means of solving the aforementioned problems are as follows:

<1> A toner including: a toner material that contains at least a binder resin, a pigment, and a pigment dispersant, wherein the pigment dispersant has an acid value of 20 mgKOH/g to 50 mgKOH/g and an amine value of 1 mgKOH/g to 50 mgKOH/g, and wherein the pigment contains at least aluminum phthalocyanine.

<2> The toner according to <1>, wherein the pigment dispersant contains at least one of a polyester-based pigment dispersant, an acrylic pigment dispersant, and a polyurethane-based pigment dispersant.

<3> The toner according to <1>, wherein the pigment dispersant has a melting point of 20° C. to 80° C.

<4> The toner according to <1>, wherein the amount of the pigment dispersant is 1 part by mass to 100 parts by mass per 100 parts by mass of the pigment.

<5> The toner according to <1>, wherein the pigment further contains copper phthalocyanine, and the mass ratio of the copper phthalocyanine to the aluminum phthalocyanine is 40:60 to 90:10.

<6> The toner according to <1>, wherein the toner material further contains a wax.

<7> The toner according to <1>, wherein the toner material further contains a binder resin precursor and a wax.

<8> The toner according to <1>, wherein the toner is produced by a method which comprises: dispersing or emulsifying in an aqueous medium an oil phase containing the toner material, to produce particles; and aggregating the particles.

<9> The toner according to <1>, wherein the toner is produced by a method which comprises: adding in an aqueous medium a dispersion liquid and an oil phase, the dispersion liquid containing a binder resin precursor composed of a modified polyester resin, the oil phase containing a fine particle dispersant; dissolving a compound that is crosslinkable with the binder resin precursor; dispersing the oil phase in the aqueous medium to prepare an emulsified dispersion liquid; and allowing the binder resin precursor to undergo crosslinking reaction or extension reaction in the emulsified dispersion liquid.

<10> The toner according to <5>, wherein the copper phthalocyanine and aluminum phthalocyanine are mixed together by solvent salt milling.

<11> The toner according to <5>, wherein the toner is produced by dry-mixing the toner material followed by melt-kneading.

<12> The toner according to claim <11>, wherein in the toner material the copper phthalocyanine and aluminum phthalocyanine are mixed together in the form of powder.

<13> A developer including the toner according to any one of <1> to <12>.

<14> A toner container including the toner according to any one of <1> to <12>.

<15> An image forming method including: forming a latent electrostatic image on a latent electrostatic image bearing member; developing the latent electrostatic image with a toner to form a visible image; transferring the visible image to a recording medium; and fixing the image to the recording medium, wherein the toner is the toner according to any one of <1> to <12>.

<16> An image forming apparatus including: a latent electrostatic image bearing member; a latent electrostatic image forming unit configured to form a latent electrostatic image on the latent electrostatic image bearing member; a developing unit configured to develop the latent electrostatic image with a toner to form a visible image; a transferring unit configured to transfer the visible image to a recording medium; and a fixing unit configured to fix the image to the recording medium, wherein the toner is the toner according to any one of <1> to <12>.

<17> A process cartridge including: a latent electrostatic image bearing member, and a developing unit configured to develop the latent electrostatic image with a toner to form a visible image, the process cartridge being detachably mounted to an image forming apparatus main body, wherein the toner is the toner according to any one of <1> to <12>.

### BRIEF DESCRIPTION OF THE SEVERAL VIEWS OF THE DRAWINGS

FIG. 1 is a schematic view showing an example of a process cartridge of the present invention.

FIG. 2 is a schematic explanatory view showing an example according to an image forming apparatus of the present invention.

FIG. 3 is a schematic view showing one embodiment of a fixing device for use in an image forming apparatus of the present invention, with a fixing belt being provided to the fixing device.

### DETAILED DESCRIPTION OF THE INVENTION

### (Toner)

A toner of the present invention contains at least a binder resin, a pigment, and a pigment dispersant, and further contains additional ingredient(s) where necessary.

The present invention can provide a cyan toner that has excellent coloring ability and standard cyan color (Japan Color) with sufficient saturation, by use of a pigment dispersant having a predetermined acid value and a predetermined amine value upon dispersing of aluminum phthalocyanine pigment, preferably a mixture pigment of copper phthalocyanine pigment and aluminum phthalocyanine pigment.

### <Pigment>

It is preferable for the pigment to contain at least aluminum phthalocyanine, preferably a mixture of copper phthalocyanine and aluminum phthalocyanine, so that the standard cyan (Japan Color) can be reproduced on standard paper.

In view of its high safety, the copper phthalocyanine pigment is preferably one having 0 to 1 chlorine atom in one molecule since such a pigment generates no PCB or dioxin when burned; examples include, for example, C.I. PIGMENT BLUE 15:3, C.I. PIGMENT BLUE 15:14, and C.I. PIGMENT BLUE 15:1.

The mass ratio between copper phthalocyanine (A) and aluminum phthalocyanine (B) in the mixture pigment, i.e., (A:B), is preferably 30:70 to 90:10, more preferably 35:65 to 90:10. A copper phthalocyanine (A) content of less than 35% by mass may result in poor reproducibility of the standard cyan (Japan Color), and a copper phthalocyanine (A) content of greater than 90% by mass may result in poor reproducibility of the standard cyan (Japan Color) and poor pigment dispersing, leading to reduction in coloring ability and clearness.

The pigment content of the toner is not specifically limited and can be appropriately determined depending on the intended purpose; however, it is preferably 1% by mass to 15% by mass, more preferably 3% by mass to 10% by mass. A pigment content of less than 1% by mass may result in low toner's coloring ability, and a pigment content of greater than 15% by mass may result in poor dispersing of pigment in toner, leading to poor coloring ability and poor toner electrical characteristics.

### <Pigment Dispersant>

When the pigment dispersant has an amine value, it adversely affects toner charging characteristics. The amine value-imparting components of the pigment dispersant are considered to be involved in this. In particular, negatively-charged toners are significantly affected by such amine value-imparting components. Accordingly, it is necessary for the pigment dispersant to have a moderate amine value while considering the balance between pigment dispersibility and toner charging characteristics.

The acid value of the pigment dispersant is 20 mgKOH/g to 50 mgKOH/g, preferably 28 mgKOH/g to 50 mgKOH/g, and more preferably 30 mgKOH/g to 50 mgKOH/g.

When the acid value of the pigment dispersant is greater than 50 mgKOH/g, the toner charge amount decreases when exposed to high-temperature, high-humidity conditions, and in addition, reactions of toner composition precursors may be inhibited. More specifically, reactions of toner composition precursors employs an active hydrogen group-containing compound as crosslinking agent or extender, which is a basic substance. When the pigment dispersant has a high acid value, the crosslinking agent or extender is bound to acidic groups of the pigment dispersant, inhibiting reactions between the toner composition precursors and crosslinking agent or extender. This leads to poor toner fixing characteristics, particularly poor hot offset resistance. When the acid value is greater than 50 mgKOH/g, acidic groups that produce acid value are associated together by hydrogen bonding, which may reduce the number of acidic groups effective in pigment dispersing. When the acid value of the pigment dispersant is less than 20 mgKOH/g, the pigment's compatibility with binder resin may become so insufficient that pigment dispersibility in toner decreases.

The amine value of the pigment dispersant is 1 mgKOH/g to 50 mgKOH/g, preferably 15 mgKOH/g to 45 mgKOH/g. When the amine value is less than 1 mgKOH/g, pigment dispersibility may decrease. Virtually, no amine groups are considered to exist that produce amine value when the amine value is less than 1 mgKOH/g. When an organic pigment is to be dispersed using a pigment dispersant, generally, amine groups are considered to adsorb to the pigment surface. Thus, when the amine value is less than 1 mgKOH/g, there are no available sites to which amine groups can be adsorbed, and thus, pigment dispersibility decreases. On the other hand, when the amine value is greater than 50 mgKOH/g, it results in abundant amine groups in the polymer chains, where they are associated together by hydrogen bonding. Thus, the number of amine groups that adsorb to the pigment surface decreases, which may result in poor pigment dispersibility.

The pigment dispersant content of the toner needs to be optimized in order for it to exhibit the above-mentioned characteristics. When the pigment dispersant content is low, pigment dispersibility decreases. When the pigment dispersant content is high, the above-mentioned storage stability, charge characteristics, and fixing characteristics may degrade.

As the pigment dispersant, there is an optimal polymer dispersant for each binder resin to be employed. When a polyester resin is employed as the binder resin, polyester-based polymer dispersants are most preferable since their ester groups are chemically interacted with polyester resins. In addition, polyurethane-based polymer dispersants are also preferable since polyurethane groups are chemically interacted with ester groups. Furthermore, acrylic dispersants also are effective, although the underlying mechanism is unclear.

The polyester-based polymer dispersants are referred to those dispersants that have a polyester skeleton as a main chain or side chain, and amine groups or acidic groups in or at the terminals of polyester skeleton.

The polyester-based pigment dispersants are not specifically limited and can be appropriately selected depending on the intended purpose; examples include, for example, AJISPER PB821, AJISPER PB822, AJISPER PB711 (available from Ajinomoto Fine-Techno Co., Inc.); and DISPARLON DA-705, DISPARLON DA-325, DISPARLON DA-725, DISPARLON DA-703-50, DISPARLON DA-234 (available from Kusumoto Chemicals Ltd.).

The acrylic pigment dispersants are not specifically limited and can be appropriately selected depending on the intended purpose; examples include, for example, Disperbyk 2000, Disperbyk 2001, Disperbyk 2020, Disperbyk 2050, Disperbyk 2150 (available from BYK Chemie).

The polyurethane-based pigment dispersants are not specifically limited and can be appropriately selected depending on the intended purpose; examples include, for example, EFKA 4010, EFKA 4009, EFKA 4015, EFKA 4047, EFKA 4050, EFKA 4055, EFKA 4060, EFKA 4080, EFKA 4520 (available from Chiba Specialty Chemicals, Inc.).

The pigment dispersant preferably has a melting point of 20° C. to 80° C., more preferably 30° C. to 75° C. When the melting point is less than 20° C., it may result in poor toner blocking resistance. When the melting point is greater than 80° C., it may result in poor low-temperature fixing ability.

The added amount of the pigment dispersant is preferably 1 part by mass to 100 parts by mass per 100 parts by mass of the pigment, more preferably 5 parts by mass to 50 parts by mass. When the added amount is less than 1 part by mass, it may result in failure to fully disperse the pigment to achieve stabilized state. When the added amount is greater than 100 parts by mass, it may result in poor quality (e.g., plasticization of binder resin, poor charge characteristics) as well as in increased costs.

The copper phthalocyanine pigment and aluminum phthalocyanine pigment may be mixed together during toner particle preparation, but are preferably mixed together in the course of pigment preparation so as to unleash their respective best performance. In order to achieve this and to avoid possible contamination during pigment preparation, it is particularly preferable to mix them by solvent salt milling during pigment preparation.

A toner of the present invention is produced by emulsifying or dispersing in an aqueous medium a solution or dispersion liquid of toner material.

The solution of toner material is prepared by dissolving toner material in a solvent, and the dispersion liquid of toner material is prepared by dispersing toner material in a solvent.

The toner material is not specifically limited as long as toner can be manufactured and can be appropriately selected depending on the intended purpose; for example, the toner material contains at least one of a monomer, a polymer, an active hydrogen group-containing compound, and a polymer capable of reacting with that active hydrogen group-containing compound and, where necessary, further contains additional ingredient(s) such as a pigment, a pigment dispersant, a releasing agent (wax), and/or a charge control agent.

The solution or dispersion liquid of toner material preferably contains an organic solvent. Namely, it is preferable to prepare the solution or dispersion liquid by dissolving or dispersing the toner material in an organic solvent. Such an organic solvent is preferably removed during or after toner particle preparation.

The organic solvent is not particularly limited and can be appropriately selected depending on the intended purpose as long as it is a solvent capable of dissolving and dispersing the toner material. Volatile organic solvents with boiling points of less than 150° C. are preferable because they can be readily removed; examples include, for example, toluene, xylene, benzene, carbon tetrachloride, methylene chloride, 1,2-dichloroethane, 1,1,2-trichloroethane, trichloroethylene, chloroform, monochlorobenzene, dichloroethylidene, methylacetate, ethylacetate, methyl ethyl ketone, and methyl isobutyl ketone. Among these organic solvents, toluene, xylene, benzene, methylene chloride, 1,2-dichloroethane, chloroform, carbon tetrachloride and the like are preferable, with ethyl acetate being most preferable. These organic solvents may be used alone or in combination.

The added amount of organic solvent is not specifically limited and can be appropriately determined depending the intended purpose; however it is preferably added in an amount of 40 parts by mass to 300 parts by mass per 100 parts by mass of the toner material, more preferably 60 parts by mass to 140 parts by mass, and still more preferably 80 parts by mass to 120 parts by mass.

### —Aqueous Medium—

The aqueous medium is not specifically limited and can be appropriately selected from those known in the art depending on the intended purpose; examples include, for example, water, solvents miscible with water, and mixtures thereof.

The solvents miscible with water are not specifically limited as long as they are miscible with water; examples include, for example, alcohols, dimethylformamide, tetrahydrofuran, cellosolves and lower ketones.

Examples of the alcohols include, for example, methanol, isopropanol and ethylene glycol. Examples of the lower ketones include, for example, acetone and methyl ethyl ketone. These can be used alone or in combination.

### —Emulsification or Dispersing—

The emulsification or dispersing of the solution or dispersion liquid of toner material in the aqueous medium is preferably effected by dispersing the solution or dispersion liquid in the aqueous medium with stirring.

The method of dispersing is not specifically limited and can be selected from known dispersing devices such as a low-speed shear disperser, high-speed shear disperser, friction disperser, high-pressure jet disperser, and supersonic disperser. Among them, a high-speed shear disperser is preferable because it is capable of adjusting the particle diameter of dispersion (oil droplets) to be within the range of 2 μm to 20 μm.

When a high-speed shear disperser is used, the rotational speed, dispersing time, dispersing temperature, etc., are not specifically limited and can be determined depending on the intended purpose. For example, the rotational speed is preferably 1,000 rpm to 30,000 rpm and more preferably 5,000 rpm to 20,000 rpm. The dispersing time is preferably 0.1 min to 5 min in the case of batch method. The dispersing temperature is preferably 0° C. to 150° C., more preferably 40° C. to 98° C. under pressure. In general, dispersing can be more easily effected at higher temperatures.

### —Toner Granulation—

The method of toner granulation or toner particle production is not specifically limited and can be appropriately selected from those known in the art; examples include, for example, toner granulation methods by suspension polymerization, emulsion polymerization aggregation or dissolution suspension, and toner granulation methods that produce toner particles while producing an adhesive base material which will be described later, with the latter methods being most preferable.

In the suspension polymerization, a colorant, a releasing agent, etc., are dispersed in an oil-soluble polymerization initiator and a polymerizable monomer, and then the resultant dispersion liquid is emulsified and dispersed in aqueous medium containing a surfactant or other solid dispersants by emulsification to be described later. After forming particles by polymerization, fine inorganic particles may be attached to the particle surface of the toner of the present invention by wet process. Preferably, the wet process is carried out after washing away excess surfactant and other agents.

Examples of the polymerizable monomer include, for example, acids such as acrylic acid, methacrylic acid, α-cyanoacrylic acid, α-cyanomethacrylic acid, itaconic acid, crotonic acid, fumaric acid, maleic acid and maleic anhydride; acrylamide, methacrylamide, diacetone acrylamide and methyloyl compounds thereof; vinylpyridine; vinylpyrrolidone; vinylimidazole; ethyleneimine; and amino group-containing acrylates or methacrylate such as dimethylaminoethyl methacrylate. Use of some of the above monomers enables introduction of functional groups to the surfaces of toner particles.

Furthermore, as a dispersant to be used, a dispersant that has acidic group or basic group can be employed so that it remains adsorbed to the particle surfaces for introduction of functional groups to them.

The emulsion polymerization uses a surfactant for emulsification a water-soluble polymerization initiator and a polymerizable monomer in water and synthesizes latex by general emulsion polymerization. Separately, a dispersion is prepared that contains a colorant, a releasing agent, etc. dispersed in an aqueous medium. The latex and dispersion are mixed, followed by aggregation to toner size and heat-fusing to prepare toner. Subsequently, attachment of fine inorganic particles is carried out by wet process. Functional groups can be introduced to the surface of toner particles by employing as latex a monomer similar to those that may be used in suspension polymerization.

The above toner granulation method that produces toner particles while producing an adhesive base material employs a toner material that contains an active hydrogen group-containing compound and a polymer capable of reacting with that active hydrogen group-containing compound, and allows the active hydrogen group-containing compound to be reacted with the polymer to produce an adhesive base material, to obtain particles composed of the adhesive base material.

The toner produced by such a toner granulation method contains an adhesive base material and, where necessary, further contains additional ingredient(s) such as a pigment, pigment dispersant, releasing agent, and/or charge control agent appropriately selected.

### —Adhesive Base Material—

The adhesive base material adheres to recording media such as paper and contains at least an adhesive polymer produced by reaction of an active hydrogen-containing compound and a polymer capable of reacting with the active hydrogen group-containing compound, and also may contain a binder resin selected from those known in the art.

The toner obtained in this way contains a pigment and a pigment dispersant and, where necessary, may further contain additional ingredient(s) such as a releasing agent and/or a charge control agent.

The weight-average molecular weight of the adhesive base material is preferably 3,000 or more, more preferably 5,000 to 1,000,000, and most preferably 7,000 to 500,000. When the weight-average molecular weight is less than 3,000, hot offset resistance may decrease.

The glass transition temperature of the adhesive base material is preferably 40° C. to 65° C., more preferably 45° C. to 65° C. When the glass transition temperature is less than 40° C. or less, it may result in poor heat resistance/storage stability. When the glass transition temperature is greater than 65° C., it may result in insufficient low temperature fixing ability. However, a toner that contains as an adhesive base material a polyester resin prepared by crosslinking reaction or extension reaction offers excellent storage stability even when the glass transition temperature is low.

The adhesive base material can be appropriately selected depending on the intended purpose; preferable examples thereof are polyester resins.

The binder resin precursor is not specifically limited and can be appropriately selected depending on the intended purpose; suitable examples are modified polyester resins capable of reacting with active hydrogen group-containing compounds.

As the modified polyester resins, isocyanate group-containing polyesters are preferable as a polymer that is reactive with active hydrogen group. Urethane bonds may be formed by addition of an alcohol upon reaction of an isocyanate group-containing polyester resin and an active hydrogen group-containing compound. The mole ratio of urethane bonds to urea bonds (as defined for the purpose of distinguishing from the urethane bonds in an isocyanate group-containing polyester prepolymer) is preferably 0 to 9, more preferably 1/4 to 4, and most preferably 2/3 to 7/3. When this molar ratio is greater than 9, hot offset resistance may decrease.

Specific examples of adhesive base material include, for example the following compounds (I) to (10): (1) a mixture of (i) polycondensation product of bisphenol A ethyleneoxide (2 mol) adduct and isophthalic acid, and (ii) urea-modified polyester prepolymer which is obtained by reacting isophorone disocyanate with a polycondensation product of bisphenol A ethyleneoxide (2 mol) adduct and isophthalic acid and modifying with isophorone diamine; (2) a mixture of (iii) a polycondensation product of bisphenol A ethyleneoxide (2 mol) adduct and terephthalic acid, and (ii) urea-modified polyester prepolymer which is obtained by reacting isophorone disocyanate with a polycondensation product of bisphenol A ethyleneoxide (2 mol) adduct and terephthalic acid, and modifying with isophorone diamine; (3) a mixture of (iv) polycondensation product of bisphenol A ethyleneoxide (2 mol) adduct, bisphenol A propyleneoxide (2 mol) adduct and terephthalic acid, and (v) urea-modified polyester prepolymer which is obtained by reacting isophorone disocyanate with polycondensation product of bisphenol A ethyleneoxide (2 mol) adduct, bisphenol A propyleneoxide (2 mol) adduct and terephthalic acid, and modifying with isophorone diamine; (4) a mixture of (vi) polycondensation product of bisphenol A propyleneoxide (2 mol) adduct and terephthalic acid, and (v) urea-modified polyester prepolymer which is obtained by reacting isophorone disocyanate with polycondensation product of bisphenol A ethyleneoxide (2 mol) adduct, bisphenol A propyleneoxide (2 mol) adduct and terephthalic acid, and modifying with isophorone diamine; (5) a mixture of (iii) polycondensation product of bisphenol A ethyleneoxide (2 mol) adduct and terephthalic acid, and (vi) urea-modified polyester prepolymer which is obtained by reacting isophorone disocyanate with polycondensation product of bisphenol A ethyleneoxide (2 mol) adduct and terephthalic acid, and modifying with hexamethylene diamine; (6) a mixture of (iv) polycondensation product of bisphenol A ethyleneoxide (2 mol) adduct, a bisphenol A propyleneoxide (2 mol) adduct and terephthalic acid, and (vi) urea-modified polyester prepolymer which is obtained by reacting isophorone disocyanate with polycondensation product of bisphenol A ethyleneoxide (2 mol) adduct and terephthalic acid, and modifying with hexamethylene diamine; (7) a mixture of (iii) polycondensation product of bisphenol A ethyleneoxide (2 mol) adduct and terephthalic acid, and (vii) urea-modified polyester prepolymer which is obtained by reacting isophorone disocyanate with polycondensation product of bisphenol A ethyleneoxide (2 mol) adduct and terephthalic acid, and modifying with ethylene diamine; (8) a mixture of (i) polycondensation product of bisphenol A ethyleneoxide (2 mol) adduct and isophthalic acid, and (viii) urea-modified polyester prepolymer which is obtained by reacting diphenylmethane disocyanate with polycondensation product of bisphenol A ethyleneoxide (2 mol) adduct and isophthalic acid, and modifying with hexamethylene diamine; (9) a mixture of (iv) polycondensation product of bisphenol A ethyleneoxide (2 mol) adduct, bisphenol A propyleneoxide (2 mol) adduct, terephthalic acid and dodecenylsuccinic anhydride, and (ix) urea-modified polyester prepolymer which is obtained by reacting diphenylmethane disocyanate with polycondensation product of bisphenol A ethyleneoxide (2 mol) adduct, bisphenol A propyleneoxide (2 mol) adduct, terephthalic acid and dodecenylsuccinic anhydride, and modifying with hexamethylene diamine; and (10) a mixture of (i) polycondensation product of bisphenol A ethyleneoxide (2 mol) adduct and isophthalic acid, and (x) urea-modified polyester prepolymer which is obtained by reacting toluene disocyanate with polycondensation product of bisphenol A ethyleneoxide (2 mol) adduct and isophthalic acid and modifying with hexamethylene diamine.

The active hydrogen group-containing compound functions as extender or crosslinking agent when a polymer reactive with the active hydrogen group-containing compound undergoes an extension or crosslinking reaction in an aqueous medium.

Specific examples of the active hydrogen group include, for example, hydroxyl groups (e.g., alcoholic hydroxyl group and phenolic hydroxyl group), amino group, carboxyl group, and mercapto group. These may be used alone or in combination.

The active hydrogen group-containing compound can be appropriately selected depending on the intended purpose. For example, in cases where the polymer reactive with the active hydrogen group-containing compound is an isocyanate group-containing polyester prepolymer, amines are preferable since the molecular weight can be increased by the extension reaction or crosslinking reaction with the polyester prepolymer.

The amines are not specifically limited and can be appropriately selected depending on the intended purpose; examples thereof include, for example, diamines, trivalent or higher polyamines, amino alcohols, amino mercaptans, amino acids, and the above amines in which amino groups are blocked. Among them, diamines, and mixtures of diamines with a small amount of the polyamines are particularly preferable. These amines can be used along or in combination.

Examples of the diamines include, for example, aromatic diamines, alicyclic diamines and aliphatic diamines. Examples of the aromatic diamines include, for example, phenylene diamine, diethyltoluene diamine and 4,4′-diaminophenylmethane. Examples of the alicyclic diamines include, for example, 4,4′-diamino-3,3′-dimethyldicyclohexylmethane, diaminocyclohexane and isophorone diamine. Examples of the aliphatic diamines include, for example, ethylene diamine, tetramethylene diamine and hexamethylene diamine. Examples of the trivalent or higher polyamines include, for example, diethylene triamine and triethylene tetramine. Examples of the amino alcohols include, for example, ethanolamine and hydroxyethylaniline. Examples of the amino mercaptans include, for example, aminoethylmercaptan and aminopropylmercaptan. Examples of the amino acids include, for example, amino propionic acid and amino capric acid. Specific examples of the above amines with blocked amino groups include, for example, ketimine compounds and oxazoline compounds, which are obtained by blocking the amino groups of the above amines with a ketone such as acetone, methyl ethyl ketone or methyl butyl ketone.

A reaction terminator may be used to stop the extension reaction, crosslinking reaction or the like between the active hydrogen group-containing compound and the polymer reactive with that compound. The reaction terminator is preferably employed for adjusting the molecular weight, etc., of the adhesive base material to be within a preferable range. Specific examples of the reaction terminator include, for example, monoamines such as diethylamine, dibutylamine, butylamine and laurylamine, and also ketimine compounds obtained by blocking their amino groups.

The ratio of the equivalent weight of isocyanate group in the prepolymer to the equivalent weight of amino group in the amine is preferably from 1/3 to 3/1, more preferably from 1/2 to 2/1, and most preferably from 2/3 to 1.5/1. When this ratio is less than 1/3, the low-temperature fixing ability may deteriorate. When the ratio is more than 3/1, the molecular weight of the urea-modified polyester decreases, possibly impairing the hot offset resistance.

The polymer reactive with an active hydrogen group (hereinafter sometimes referred to as “prepolymer”) can be appropriately selected from known resins and the like, with examples thereof including, for example, polyol resins, polyacrylic resins, polyester resins, epoxy resins, and derivatives thereof. These resins may be used alone or in combination. Among them, polyester resins are especially preferable for their higher flowability and transparency when melted.

Examples of functional groups reactive with the active hydrogen group of the prepolymer include, for example, isocyanate group, epoxy group, carboxyl group, and a functional group having the formula —COC—, with isocyanate group being preferable. The prepolymer may contain one or more of these functional groups.

As the prepolymer, it is preferable to use a polyester resin having isocyanate group or the like that can produce urethane bonds, since by so doing the molecular weights of polymer components can be readily adjusted and oil-less low-temperature fixing ability can be ensured in dry toner, particularly since it is possible to ensure excellent releasing ability and fixing ability even when no oil supply mechanism is provided for providing a releasing oil to the heated medium for toner fixing.

The isocyanate group-containing polyester prepolymer can be appropriately selected depending on the intended purpose; specific examples include, for example, reaction products of polyisocyanate and active hydrogen group-containing polyester resins obtained by polycondensation of polyols with polycarboxylic acids.

The polyols are not specifically limited and can be appropriately selected depending on the intended purpose; examples include, for example, diols, trivalent or higher polyols, and mixtures of diols and trivalent or higher polyols. Among these, preferable are diols and mixtures of diols and a small amount of trivalent or higher polyols. These polyols may be used alone or in combination.

Specific examples of the diols include, for example, alkylene glycols such as ethylene glycol, 1,2-propylene glycol, 1,3-propylene glycol, 1,4-butanediol, and 1,6-hexanediol; oxyalkylene group-containing diols such as diethylene glycol, triethylene glycol, dipropylene glycol, polyethylene glycol, polypropylene glycol, and polytetramethylene ether glycol; alicyclic diols such as 1,4-cyclohexane dimethanol and hydrogenated bisphenol A; alkylene oxide adducts of the alicyclic diols, such as those obtained by adding an alkylene oxide such as ethylene oxide, propylene oxide, butylene oxide or the like to the alicyclic diols; bisphenols such as bisphenol A, bisphenol F, and bisphenol S; and alkylene oxide adducts of bisphenols, such as those obtained by adding an alkylene oxide such as ethylene oxide, propylene oxide, or butylene oxide to the bisphenols. The number of carbon atoms of the alkylene glycols is preferably 2 to 12. Among them, preferable are alkylene glycols of 2 to 12 carbon atoms and alkylene oxide adducts of bisphenols, with alkylene oxide adducts of bisphenols and mixtures of alkylene oxide adducts of bisphenols and alkylene glycols of 2 to 12 carbons being most preferable.

As the trivalent or higher polyols, for example, trivalent or higher aliphatic alcohols, trivalent or higher polyphenols, or alkylene oxide adducts of trivalent or higher polyphenols are preferable. Examples of the trivalent or higher aliphatic alcohols include, for example, glycerine, trimethylol ethane, trimethylol propane, pentaerythritol, and sorbitol. Examples of the trivalent or higher polyphenols include, for example, trisphenol PA, phenol novolac, and cresol novolac. Specific examples of the alkylene oxide adducts of above-mentioned trivalent or higher polyphenols include, for example, those obtained by adding an alkylene oxide such as ethylene oxide, propylene oxide, or butylene oxide to trivalent or higher polyphenols. When the diol and trivalent or higher alcohol is to be mixed, the amount of trivalent or higher alcohol relative to the diol is preferably 0.01% by mass to 10% by mass, more preferably 0.01% by mass to 1% by mass.

The polycarboxylic acids are not specifically limited and can be appropriately depending on the intended purpose; examples include, for example, dicarboxylic acids, trivalent or higher carboxylic acids, and mixtures thereof, with dicarboxylic acids and the mixtures of dicarboxylic acids and a small amount of trivalent or higher carboxylic acids being preferable. These polycarboxylic acids may be used along or in combination.

Examples of the dicarboxylic acids include, for example, dialkanoic acids, dialkenoic acids, and aromatic dicarboxylic acids. Examples of the dialkanoic acids include, for example, succinic acid, adipic acid, and sebacic acid. The number of carbon atoms of the dialkenoic acids preferably is 4 to 20, with specific examples being maleic acid, fumaric acid, and the like. The number of carbon atoms of the aromatic dicarboxylic acids is preferably 8 to 20, with specific examples being phthalic acid, isophthalic acid, terephthalic acid, naphthalendicarboxylic acid, and the like. Among them, dialkenoic acids of 4 to 20 carbon atoms and aromatic dicarboxylic acids of 8 to 20 carbon atoms are preferable.

As the trivalent or higher carboxylic acids, trivalent or higher aromatic carboxylic acids can be used, which preferably have 9 to 20 carbon atoms. Examples thereof include, for example, trimellitic acid, and pyromellitic acid.

The polycarboxylic acids may also be acid anhydrides or lower alkyl esters of any of dicarboxylic acids, trivalent or higher carboxylic acids, and mixtures thereof. Examples of the lower alkyl ester include, for example, methyl ester, ethyl ester, and isopropyl ester.

When the dicarboxylic acid and trivalent or higher carboxylic acid is to be mixed, the amount of the trivalent or higher carboxylic acid relative to the dicarboxylic acid is preferably 0.01% by mass to 10% by mass, more preferably 0.01% by mass to 1% by mass.

The ratio of the equivalent weight of hydroxyl group in the polyol to the equivalent weight of carboxyl group in the polycarboxylic acid upon polycondensation of the polyol with polycarboxylic acid is preferably 1 to 2, more preferably 1 to 1.5, and most preferably 1.02 to 1.3.

The amount of the polyol-derived component in the isocyanate group-containing polyester prepolymer is preferably 0.5% by mass to 40% by mass, more preferably 1% by mass to 30% by mass and most preferably 2% by mass to 20% by mass. When the amount is less than 0.5% by mass, it may result in poor hot offset resistance, which makes it difficult to ensure heat resistance/storage stability and low-temperature fixing ability at the same time. When the amount is greater than 40% by mass, it may result in reduced low-temperature fixing ability.

The above polyisocyanates are not specifically limited and can be appropriately selected depending on the intended purpose; examples include, for example, aliphatic polyisocyanates, alicyclic polyisocyanates, aromatic diisocyanates, aromatic aliphatic diisocyanates, isocyanurates, and blocked products thereof blocked using phenol derivative, oxime, caprolactam, or the like.

Examples of the aliphatic diisocyanates include, for example, tetramethylene diisocyanate, hexamethylene diisocyanate, 2,6-diisocyanate methyl caproate, octamethylene diisocyanate, decamethylene diisocyanate, dodecamethylene diisocyanate, tetradecamethylene diisocyanate, trimethyl hexane diisocyanate, and tetramethyl hexane diisocyanate. Examples of the alicyclic polyisocyanates include, for example, isophorone diisocyanate, and cyclohexylmethane diisocyanate. Examples of the aromatic diisocyanates include, for example, tolylene diisocyanate, diphenylmethane diisocyanate, 1,5-naphthylene diisocyanate, diphenylene-4,4′-disocyanate, 4,4′-diisocyanato-3,3′-dimethyl diphenyl, 3-methyldiphenyl methane-4,4′-diisocyanate, and diphenylether-4,4′-diisocyanate. Examples of the aromatic aliphatic diisocyanates include, for example, α,α,α′,α′-tetramethyl xylylene diisocyanate. Examples of the isocyanurates include, for example, tris-isocyanatoalkyl-isocyanurate, and tris(isocyanatocycroalkyl)isocyanurate. These may be used alone or in combination.

In general, the ratio of the equivalent weight of isocyanate group in the polyisocyanate to the equivalent weight of hydroxyl group in the polyester resin upon reaction of the polyisocyanate with hydroxyl group-containing polyester resin is preferably 1 to 5, more preferably 1.2 to 4, and most preferably 1.5 to 3. When this ratio is greater than 5, it may result in poor low-temperature fixing ability. When the ratio is less than 1, it may result in poor offset resistance.

The amount of the polyisocyanate-derived component in the isocyanate group-containing polyester prepolymer is preferably 0.5% by mass to 40% by mass, more preferably 1% by mass to 30% by mass, and further preferably 2% mass to 20% by mass. If the amount is less than 0.5% by mass, it may result in poor offset resistance. If the amount is greater than 40% by mass, it may result in poor low-temperature fixing ability.

The average number of isocyanate groups per one molecule of the polyester prepolymer is preferably 1 or more, more preferably 1.2 to 5, and most preferably 1.5 to 4. When the average number is less than 1, the molecular weight of the urea-modified polyester resin decreases and thus hot offset resistance may decrease.

The weight-average molecular weight of the polymer reactive with an active hydrogen group is preferably 1,000 to 30,000, more preferably 1,500 to 15,000. When the weight-average molecular weight is less than 1,000, it may result in poor heat resistance/storage stability. When the weight-average molecular weight is greater than 30,000, it may result in poor low-temperature fixing ability.

The weight average molecular weight can be found for instance by gel permeation chromatography (GPC) of tetrahydrofuran (THF)-soluble matter as follows.

At first, a column is equilibrated in a heat chamber at the interior temperature of 40° C. At this temperature tetrahydrofuran (THF), a column solvent, is passed through the column at the flow rate of 1 ml/min. To this column, 50-200 μl of tetrahydrofuran solutions with sample concentrations of to 0.05% by mass to 0.6% by mass were added. In this measurement, the molecular weight distribution is obtained from the relationship between the logarithm values of calibration curve prepared from several standard samples and counts. The standard samples for calibration are, for example, standard monodispersed polystyrene samples respectively having a molecular weight of 6×10², 2.1×10², 4×10², 1.75×10⁴, 1.1×10⁵, 3.9×10⁵, 8.6×10⁵, 2×10⁶, and 4.48×10⁶ (available from Pressure Chemical Co. or Toyo Soda Co. Ltd.) It is preferable to use about 10 standard samples. Note that a refractive index (RI) detector can be used as a detector.

In the present invention any binder resin can be appropriately used depending on the intended purpose, and polyester resins and the like can be used; however, unmodified polyester resins are preferable. By using such unmodified polyester resins the low-temperature fixing ability and glossiness can be improved.

Examples of the unmodified polyester resins include, for example, polycondensates of polyols and polycarboxylic acids. It is preferable that a part of the unmodified polyester resin be compatibilized with a urea-modified polyester resin, i.e., that the unmodified polyester resin and urea-modified polyester resin have similar structure that enables compatibilization, for the purpose of improving the low-temperature fixing ability and hot offset resistance.

The weight-average molecular weight of the unmodified polyester resin is preferably 1,000 to 30,000, more preferably 1,500 to 15,000. When the weight-average molecular weight is less than 1,000, it may result in poor heat resistance/storage stability. For this reason, it is preferable that the amount of components having a weight-average molecular weight of less than 1,000 be 8% by mass to 28% by mass. When the weight-average molecular weight is greater than 30,000, it may result in poor low-temperature fixing ability.

The glass transition temperature of the unmodified polyester resin is preferably 30° C. to 70° C., more preferably 35° C. to 60° C., and further preferably 35° C. to 55° C. When the glass transition temperature is less than 30° C., it may result in poor heat resistance/storage stability. When the glass transition temperature is greater than 70° C., it may result in poor low-temperature fixing ability.

The hydroxyl value of the unmodified polyester resin is preferably 5 mgKOH/g or more, more preferably 10 mgKOH/g to 120 mgKOH/g, and further preferably 20 mgKOH/g to 80 mgKOH/g. When the hydroxyl value is less than 5 mgKOH/g, it may become difficult to ensure excellent heat resistance/storage stability and low-temperature fixing ability.

The acid value of the unmodified polyester resin is 1.0 mgKOH/g to 50.0 mgKOH/g, more preferably 1.0 mgKOH/g to 30.0 mgKOH/g. By setting the acid value within these ranges, the resultant toner becomes likely to be negatively charged.

When a toner contains a unmodified polyester resin, the mass ratio of the isocyanate group-containing polyester prepolymer to the unmodified polyester resin is preferably 5/95 to 25/75, more preferably 10/90 to 25/75. When the mass ratio is less than 5/95, it may result in poor hot offset resistance. When the mass ratio is greater than 25/75, it may result in poor low-temperature fixing ability and low glossiness.

In addition to the above-mentioned ingredients, the toner of the present invention can further contain a releasing agent, charge control agent, finer resin particles, fine inorganic particles, flow improver, cleaning improver, magnetic material, metallic soap, etc.

The releasing agent is not specifically limited and can be appropriately selected from those known in the art; examples include, for example, carbonyl group-containing waxes, polyolefin waxes, and long-chain hydrocarbons. These may be used alone or in combination. Among these, carbonyl group-containing waxes are preferable.

Examples of the carbonyl group-containing wax include, for example, esters having alkanoic acid residues such as carnauba wax, montan wax, trimethylolpropane tribehenate, pentaerythritol tetrabehenate, pentaerythritol diacetate dibehenate, glycerin tribehenate, and 1,18-octadecan diol distearate; esters having alkanol residues such as trimellitic tristearate and distearyl maleate; amides having alkanoic acid residues such as behenyl amide; amides having monoamine residues such as trimellitic acid tristearyl amide; and dialkyl ketones such as distearyl ketone. Among them, esters having polyalkanoic acid residues are most preferable Examples of the polyolefin waxes include, for example, polyethylene wax and polypropylene wax. Examples of the long-chain hydrocarbons include, for example, paraffin waxes and Sasol waxes.

The melting point of the above waxes (releasing agents) is preferably 40° C. to 160° C., more preferably 50° C. to 120° C., and most preferably 60° C. to 90° C. When the melting point is less than 40° C., it may adversely affect the wax's heat resistance/storage stability. When the melting point is greater than 160° C., it may result in cold offset upon low-temperature fixing.

The melt viscosity of the releasing agent, as measured at a temperature that is 20° C. higher than the melting point of the wax, is preferably 5 cps to 1000 cps, more preferably 10 cps to 100 cps. When the melt viscosity is less than 5 cps, it may result in poor releasing ability. When the melt viscosity is greater than 1,000 cps, it may result in failure to provide the effects of improving the offset resistance and the low-temperature fixing ability.

The releasing agent content of the toner preferably 40% by mass or less, more preferably 3% by mass to 30% by mass. When the releasing agent content is greater than 40% by mass, it may result in poor toner flowability.

The charge control agent is not specifically limited and can be appropriately selected from those known in the art depending on the intended purpose; it is preferable to employ such a charge control agent that is close to either transparent or white as those made of colored materials change the color tone. Examples of charge control agent include, for example, triphenylmethane dyes, molybdic acid chelate pigments, rhodamine dyes, alkoxy amines, quaternary ammonium salts such as fluorine-modified quaternary ammonium salts, alkylamides, phosphorous or compounds thereof, tungsten or compounds thereof, fluorine surfactants, metallic salts of salicylic acid, and metallic salts of salicylic acid derivatives. These may be used alone or in combination.

The charge control agent may be any of commercially available products; specific examples include, for example, Bontron P-51 (quaternary ammonium salt), Bontron E-82 (oxynaphthoic acid metal complex), Bontron E-84 (salicylic acid metal complex), and Bontron E-89 (phenol condensate) available from Orient Chemical Industries, Ltd.; TP-302 and TP-415 (both quaternary ammonium salt molybdenum metal complex) available from Hodogaya Chemical Co.) Copy Charge PSY VP2038 (quaternary ammonium salt), Copy Blue PR (triphenylmethane derivative), Copy Charge NEG VP2036 and Copy Charge NX VP434 (both quaternary ammonium salt) available from Hoechst Ltd.); LRA-901 and LR-147 (both boron metal complex) available from Japan Carlit Co., Ltd.; and quinacridone, azo pigment and other high-molecular weight compounds having sulfonic group, carboxyl group, quaternary ammonium salt, or the like.

The charge control agent may be dissolved and/or dispersed in the toner material after kneading with a masterbatch, may be dissolved or dispersed into a solvent together with toner ingredients, or may be immobilized to the surface of the resultant toner particles.

The charge control agent content of toner depends on the type of binder resin, presence of additives, and method of dispersing; however, it is preferably 0.1% by mass to 10% by mass, and more preferably 0.2% by mass to 5% by mass based on the binder resin amount. When charge control agent content is less than 0.1% by mass, it may result in poor charge control. When the content is greater than 10% by mass, the charge amount of toner becomes so high that the electrostatic attraction force that attracts toner particles to the developing roller increases, which may cause reduction in developer flowability or image density degradation.

### —Resin Particles—

The resin particles are not specifically limited as long as they are made of resin capable of forming an aqueous dispersion liquid in an aqueous medium, and any resin can be selected from those known in the art. The fine resin particles may be made of either thermoplastic resin or thermosetting resin. Specific examples include, for example, vinyl resins, polyurethane resins, epoxy resins, polyester resins, polyamide resins, polyimide resins, silicone resins, phenol resins, melamine resins, urea resins, aniline resins, ionomer resins, and polycarbonate resins. Among these, the fine resin particles are preferably formed of at least one resin selected from the group consisting of vinyl resins, polyurethane resins, epoxy resins and polyester resins, because an aqueous dispersion liquid of fine, spherical resin particles can be readily prepared. These resins may be used alone or in combination.

The vinyl resins are polymers prepared by homopolymerization or copolymerization of a vinyl monomer. Specific examples of the vinyl resins include, for example, styrene-(meth)acrylate resins, styrene-butadiene copolymers, (meth)acrylate-acrylic acid ester copolymers, styrene-acrylonitrile copolymers, styrene-maleic anhydride copolymers, and styrene-(meth)acrylate copolymers.

The fine resin particles may be formed of a copolymer prepared by polymerization of a monomer containing two or more unsaturated groups. Such a monomer can be appropriately selected depending on the intended purpose; examples include, for example, a sodium salt of sulfate ester of methacrylic acid ethylene oxide adduct (Eleminol RS-30, available from Sanyo Chemical Industries, Ltd.), divinylbenzene, and 1,6-hexane-diol acrylate.

The fine resin particles may be prepared by any known polymerization method, and are preferably prepared as an aqueous dispersion liquid. Examples of the method of preparation of the aqueous dispersion liquid include, for example, in the case of vinyl resins, a method of polymerizing a vinyl monomer by suspension-polymerization, emulsification polymerization, seed polymerization, or dispersion-polymerization; and in the case of polyaddition resins and condensation resins such as polyester resins, polyurethane resins and epoxy resins, a method in which a precursor (monomer, oligomer or the like) or solution containing the precursor is dispersed in an aqueous medium in the presence of a dispersant, and cured by heating or addition of a curing agent, a method in which a suitably selected emulsifier is dissolved in a precursor (monomer, oligomer or the like) or solution containing the precursor followed by addition of water to effect phase inversion emulsification, a method in which a resin is pulverized with a mechanical rotation-type, or jet-type pulverizer followed by classification to produce resin particles, and the resin particles are dispersed in water under the presence of a suitable dispersant, a method in which are deposited by addition of a poor solvent to resin solution or by cooling resin solution prepared by dissolving resin into a solvent by heating, the solvent is removed, and the resin particles is dispersed in water under the presence of a suitable dispersant, a method in which resin solution is dispersed in water under the presence of a suitable dispersant, followed by solvent removal by heating and vacuuming, and a method in which a suitable emulsifier is added into resin solution, followed by phase inversion emulsification by addition of water.

### —Fine Inorganic Particles—

Examples of the fine inorganic particles include, for examples, fine particles made of silica, alumina, titanium oxide, barium titanate, magnesium titanate, calcium titanate, strontium titanate, iron oxide, copper oxide, zinc oxide, tin oxide, quartz sand, clay, mica, silicic pyroclastic rock, diatomaceous earth, chromic oxide, cerium oxide, iron oxide red, antimony trioxide, magnesium oxide, zirconium oxide, barium sulfate, barium carbonate, calcium carbonate, silicon carbide, or silicon nitride. These compounds may be used alone or in combination.

The primary particle diameter of the fine inorganic particles is preferably 5 nm to 2 μm, more preferably 5 nm to 500 nm. The specific surface area of the fine inorganic particles, as measured by BET method, is preferably 20 m²/g to 500 m²/g.

The fine inorganic particle content of toner is preferably 0.01% by mass to 5.0% by mass, more preferably 0.01% by mass to 5.0% by mass.

Surface treatment with the flow improver improves the hydrophobic nature of the toner surface, preventing degradation of flow characteristics and charge characteristics under high-humidity conditions. Specific examples of the flow improver include, for example, silane coupling agents, silylating agents, fluorinated alkyl group-containing silane coupling agents, organic titanate-based coupling agents, aluminum-based coupling agents, silicone oils, and modified-silicone oils.

When the above cleaning improver is added in the toner, removal of the developer remained on the photoconductor and first transfer medium after transfer is facilitated. Specific examples of the cleaning improver include, for example, stearic acid, fatty acid metal salts such as zinc steareate and calcium steareate, and resin particles obtained by soap-free emulsion polymerization, such as methyl polymethacrylate particles and polystyrene particles. The resin particles preferably have a narrow particle size distribution and preferably have a volume-average particle diameter of 0.01 μm to 1 μm.

The magnetic materials are not specifically limited and can be appropriately selected from those known in the art depending on the intended purpose; examples include, for example, iron powder, magnetite, and ferrite, with white magnetic materials being preferable in view of color tone.

### <Toner Manufacturing Method>

The toner manufacturing method is not specifically limited and can be appropriately selected from known toner manufacturing methods; examples include, for example, kneading/pulverization, polymerization, dissolution suspension, and spraying granulation.

The kneading/pulverization method melt-kneads a toner material that contains, for example, at least a binder resin, pigment and pigment dispersant, and pulverizes and classifies the resultant kneaded product to produce base particles of the toner.

In the melt-kneading, the toner material is mixed and then melt-kneaded in a melt kneader. The melt-kneading is effected after dry mixing of the toner material. It is preferable that copper phthalocyanine and aluminum phthalocyanine be previously mixed in the form of powder.

As the melt kneader, a uniaxial- or biaxial-consecutive kneader, or a batch type kneader using a roll mill can be employed. For example, KTK type biaxial extruder manufactured by KOBE STEEL., LTD.; a TEM type biaxial extruder manufactured by TOSHIBA MACHINE CO., LTD.; a biaxial extruder manufactured by KCK; a PCM type biaxial extruder manufactured by IKEGAI, LTD.; and a co-kneader manufactured by BUSS are preferably used. It is preferred that these melt kneaders be used under appropriate conditions where no breakage of the molecular chains of the binder resin occurs. Specifically, the melt-kneading temperature is adjusted referring to the softening point of the binder resin. When the melt-kneading temperature is much higher than the softening point, extensive molecular chain breakage occurs. When the melt-kneading temperature is much lower than the softening point, it may result in poor dispersing.

In the pulverization, the kneaded product obtained in the kneading is pulverized. Specifically, in the pulverization, it is preferable that the obtained kneaded product be coarsely crushed and then finely pulverized. Examples of the pulverizing method include a method in which a kneaded product is made collided with a collision plate in a jet stream, a method in which particles are made collided with each other, and a method in which a kneaded product is pulverized in a gap between a mechanically rotating roller and a stirrer.

In the classification, the pulverized product obtained in the pulverization is classified so that the particles have predetermined particle diameters. The classification can be effected by removing fine particles using, for example, a cyclone, a decanter, or a centrifugal separator.

When the pulverization and classification are completed, the pulverized product is classified in an airflow by centrifugal force to produce toner base particles having predetermined particle diameters.

Subsequently, an external additive is added to the toner base particles. The toner base and the external additive are mixed and stirred using a mixer, whereby the external additive is pulverized so that surfaces of the toner base particles are coated with it. At this time, it is important that the external additive such as inorganic particles or resin fine particles be uniformly and firmly secured to the toner base particles in order to ensure durability.

As the toner manufacturing method by polymerization, a method of producing toner base particles while producing an adhesive base material is described below. In this method, preparation of aqueous medium phase, preparation of toner material-containing liquid, emulsification or dispersing of toner material, production of adhesive base material, solvent removal, synthesis of a polymer reactive with active hydrogen group, synthesis of an active hydrogen group-containing compound, etc., are carried out.

Preparation of the Aqueous Medium Phase can be Achieved by dispersing resin particles into an aqueous medium. The added amount of the resin particles in the aqueous medium is preferably 0.5% by mass to 10% by mass.

Preparation of the Toner Material-Containing Liquid (Toner solution) can be achieved by dissolving and/or dispersing in a solvent a toner material containing an active hydrogen group-containing compound, polymer reactive with an active hydrogen group, colorant, pigment, releasing agent, charge control agent, unmodified polyester resin, etc.

In the toner material ingredients except for the polymer reactive with an active hydrogen group may be added in the aqueous medium upon dispersing of fine resin particles in the aqueous medium, or may be added in the aqueous medium upon addition of the toner solution in the aqueous medium.

Emulsification or dispersing of the toner material can be achieved by dispersing of the toner solution in the aqueous medium. By allowing the active hydrogen group-containing compound and polymer reactive with an active hydrogen group to undergo extension reaction and/or crosslinking reaction upon emulsification or dispersing of the toner material, an adhesive base material is produced.

The adhesive base material (e.g., urea-modified polyester resin) may be produced by emulsifying or dispersing in an aqueous medium a solution containing a polymer reactive an active hydrogen group (e.g., polyester prepolymer) together with an active hydrogen group-containing compound (e.g., amine) so that they undergo extension reaction and/or crosslinking reaction in the aqueous medium, may be produced by emulsifying or dispersing toner solution in an aqueous medium in which an active hydrogen group-containing compound has been previously added so that they undergo extension reaction and/or crosslinking reaction in the aqueous medium, or may be produced by emulsifying or dispersing toner solution in an aqueous medium and adding an active hydrogen group-containing compound so that they undergo extension reaction and/or crosslinking reaction from particle interfaces in the aqueous medium. When effecting the extension reaction and/or crosslinking reaction from particle interfaces, formation of urea-modified polyester resin is favored on the toner particle surfaces being produced; thus it is possible to form a concentration gradient of urea-modified polyester resin in the toner particles.

The reaction conditions used for the production of the adhesive base material is not particularly limited and can be appropriately determined depending on the combinations of the polymer reactive with an active hydrogen group and active hydrogen group-containing compound. A suitable reaction time is preferably from 10 minutes to 40 hours, more preferably from 2 hours to 24 hours. A suitable reaction temperature is preferably 150° C. or less, more preferably from 40° C. to 98° C.

A suitable method of stably forming a dispersion liquid containing the active hydrogen group-containing compound and polymer reactive with an active hydrogen group (e.g. isocyanate group-containing polyester prepolymer is, for example, a method in which a toner solution, prepared by dissolving or dispersing in a solvent a toner material containing the polymer reactive with an active hydrogen group, pigment, pigment dispersant, releasing agent, charge control agent, unmodified polyester resin, etc., is added and dispersed by shear force.

The dispersing can be achieved using any known disperser; examples include, for example, a low-speed shear disperser, high-speed shear disperser, friction disperser, high-pressure and jet disperser, supersonic disperser. Of these, the high-speed shear disperser is preferable, because it is capable of adjusting the particle diameter of the dispersants to be within a range of 2 μm to 20 μm.

When the high-speed shear disperser is used, conditions like rotational speed, dispersing time, dispersing temperature, etc., can be determined depending on the intended purpose. The rotational speed is preferably 1,000 rpm to 30,000 rpm, more preferably 5,000 rpm to 20,000 rpm. The dispersing time is preferably 0.1 minutes to 5 minutes in the case of batch method. The dispersing temperature is preferably 0° C. to 150° C., more preferably 40° C. to 98° C. under pressure. In general, dispersing can be more easily effected at higher temperatures.

The amount of aqueous medium for emulsification or dispersing of toner material is preferably 50 parts by mass to 2,000 parts by mass, more preferably 100 parts by mass to 1,000 parts by mass per 100 parts by mass of toner material. When the aqueous medium amount is less than 50 parts by mass, it may result in poor dispersing of toner material and thus toner base particles with a desired particle diameter cannot be obtained. When the aqueous medium amount is greater than 2,000 parts by mass, it may result in high manufacturing costs.

The step of emulsifying or dispersing toner solution preferably employs a dispersant for the purpose of stabilizing the dispersion (e.g., oil droplets) to achieve desired shape, and making the particle size distribution sharp.

The dispersant can be appropriately selected depending on the intended purpose; examples include, for example, surfactants, poor water-soluble inorganic dispersants, and polymeric protective colloids, with surfactants being preferable. These dispersants may be used alone or in combination.

Examples of the surfactants include, for example, anionic surfactants, cationic surfactants, nonionic surfactants, and ampholytic surfactants.

Examples of the anionic surfactants include, for example, alkylbenzene sulfonates, α-olefin sulfonates, and phosphates. Among them, those having fluoroalkyl groups are preferable. Examples of the fluoroalkyl group-containing anionic surfactants include, for example, fluoroalkyl carboxylic acids having 2 to 10 carbon atoms or metal salts thereof, disodium perfluorooctane sulfonylglutamate, sodium-3-{omega-fluoroalkyl (C₆-C₁₁)oxy}-1-alkyl(C₃-C₄) sulfonate, sodium-3-{omega-fluoroalkanoyl(C₆-C₈)—N-ethylamino}-1-propanesulfonate, fluoroalkyl(C₁₁-C₂₀) carboxylic acids or metal salts thereof, perfluoroalkyl(C₇-C₁₃) carboxylic acids or metal salts thereof, perfluoroalkyl(C₄-C₁₂) sulfonic acids or metal salts thereof, perfluorooctanesulfonic acid diethanol amide, N-propyl-N-(2-hydroxyethyl)perfluorooctanesulfone amide, perfluoroalkyl(C₆-C₁₀)sulfoneamidepropyltrimethylammonium salts, salts of perfluoroalkyl (C₆-C₁₀)—N-ethylsulfonyl glycin, and monoperfluoroalkyl(C₆-C₁₆)ethylphosphoric acid esters.

Examples of commercially available products of the fluoroalkyl group-containing surfactants include, for example, Surflon S-111, S-112 and S-113 (by Asahi Glass Co.); Frorard FC-93, FC-95, FC-98 and FC-129 (by Sumitomo 3M Ltd.); Unidyne DS-101 and DS-102 (by Daikin Industries, Ltd.); Megafac F-110, F-120, F-113, F-191, F-812 and F-833 (by Dainippon Ink and Chemicals, Inc.); ECTOP EF-102, 103, 104, 105, 112, 123A, 123B, 306A, 501, 201 and 204 (by Tohchem Products Co.); Ftergent F-100 and F150 (by Neos Co.).

Examples of the cationic surfactants include, for example, amine salts such as alkyl amine salts, aminoalcohol fatty acid derivatives, polyamine fatty acid derivatives, and imidazoline; and quaternary ammonium salts such as alkyltrimethyl ammonium salts, dialkyldimethyl ammonium salts, alkyldimethyl benzyl ammonium salts, pyridinium salts, alkyl isoquinolinium salts, and benzethonium chloride. Among them, preferable examples are primary, secondary or tertiary fluoroalkyl group-containing aliphatic amine acids, aliphatic quaternary ammonium salts such as perfluoroalkyl(C₆-C₁₀)sulfoneamidepropyltrimethylammonium salts, benzalkonium salts, benzetonium chloride, pyridinium salts, and imidazolinium salt. Specific examples of the commercially available products thereof include, for example, Surflon S-121 (by Asahi Glass Co.), Frorard FC-135 (by Sumitomo 3M Ltd.), Unidyne DS-202 (by Daikin Industries, Ltd.), Megafac F-150 and F-824 (by Dainippon Ink and Chemicals, Inc.), Ectop EF-132 (by Tohchem Products Co.), and Ftergent F-300 (by Neos Co.).

Examples of the nonionic surfactants include, for example, fatty acid amide derivatives, and polyhydric alcohol derivatives.

Examples of the ampholytic surfactants include, for example, alanine, dodecyldi(aminoethyl)glycin, di(octylaminoethyl)glycin, and N-alkyl-N,N-dimethylammonium betaine.

Examples of the poor water-soluble inorganic dispersants include, for example, tricalcium phosphate, calcium carbonate, titanium oxide, colloidal silica, and hydroxyl apatite.

Examples of the polymeric protective colloids include, for example, homopolymers or copolymers prepared by polymerization of a carboxyl group-containing monomer, hydroxyl group-containing alkyl(meth)acrylate, vinyl ether, vinyl carboxylate, amide monomer, acid chloride monomer, or monomer containing a nitrogen atom or heterocyclic ring thereof; polyoxyethylene resins; and celluloses. The homopolymers or copolymers obtained by polymerization of any of the above monomers encompass those having vinyl alcohol-derived units.

Examples of the carboxyl group-containing monomer include, for example, acrylic acid, methacrylic acid, α-cyanoacrylic acid, α-cyanomethacrylic acid, itaconic acid, crotonic acid, fumaric acid, maleic acid, and maleic anhydride. Examples of the hydroxyl group-containing alkyl(meth)acrylate monomer include, for example, β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycol monoacrylate, diethyleneglycol monomethacrylate, glycerin monoacrylate, and glycerin monomethacrylate. Specific examples of the vinyl ether include, for example, vinyl methyl ether, vinyl ethyl ether, and vinyl propyl ether. Examples of vinyl carboxylate include, for example, vinyl acetate, vinyl propionate, and vinyl butyrate. Examples of the amide monomer include, for example, acrylamide, methacrylamide, diacetone acrylicamide, N-methylolacrylamide, N-methylolmethacrylamide. Examples of the acid chloride include, for example, acrylic chloride, and methacrylic chloride. Examples of the homopolymers having a nitrogen atom or heterocyclic ring thereof include, for example, vinyl pyridine, vinyl pyrrolidone, vinyl imidazole, and ethyleneimine. Examples of the polyoxyethylene resins include, for example, polyoxyethylene, polyoxypropylene, polyoxyethylene alkylamines, polyoxypropylene alkylamines, polyoxyethylene alkylamides, polyoxypropylene alkylamides, polyoxyethylene nonylphenylether, polyoxyethylene laurylphenylether, polyoxyethylene phenyl stearate, and polyoxyethylene phenyl nonanoate. Examples of the celluloses include, for example, methyl cellulose, hydroxyethyl cellulose, and hydroxypropyl cellulose.

Upon emulsification or dispersing of toner material, a dispersant is used as needed. Examples of the dispersant include, for example, those compounds capable being dissolved in acid or alkali, such as calcium phosphate. When calcium phosphate is employed, it can be removed by dissolving it in hydrochloric acid or the like and followed by washing with water, or by enzymatic decomposition.

The extension reaction and/or crosslinking reaction for production of adhesive base material can employ a catalyst; examples include, for example, dibutyltin laurate, and dioctyltin laurate.

The removal of the organic solvent from the obtained dispersion liquid (e.g., emulsified slurry) is carried out, for example, by any of the following methods: a method in which the temperature the whole reaction system is gradually increased for evaporation the organic solvent; and a method in which the dispersion liquid is sprayed in a dry atmosphere for removal of the organic solvent from the oil droplets.

Once the organic solvent has been removed, toner particles are formed. The toner particles may be washed and dried, and where necessary, can be classified. The classification is, for example, carried out using a cyclone, decanter, or centrifugal separation in the solution for removal of fine particles. Alternatively, the classification is carried out after the toner particles have been dried.

The thus obtained toner particles may be mixed with particles of such agents as a colorant, releasing agent, and/or charge control agent. At this time, mechanical impact may be applied to the toner particles so as to prevent releasing agent particles, etc., from being come off from the toner base particle surface.

Examples of the method of application of mechanical impact include, for example, a method in which impact is applied by rotating a blade at high speeds, and a method in which impact is applied by putting mixed particles into a high-speed air flow and accelerating the air speed such that the particles collide with one another or that the particles are crashed into a proper collision plate. Examples of the device employing this method include, for example, Angmill (by Hosokawamicron Corp.), modified I-type mill (by Nippon Pneumatic Mfg. Co., Ltd.) to decrease pulverization air pressure, hybridization system (by Nara Machinery Co., Ltd.), kryptron system (by Kawasaki Heavy Industries, Ltd.), and automatic mortar.

The toner of the present invention can be used in various fields, but can be suitably used for image formation by electrophotography.

The volume-average particle diameter of the toner of the present invention is preferably 3 μm to 8 μm, more preferably 4 μm to 7 μm. When the volume-average particle diameter is less than 3 μm, in the case of two-component developer, toner fusion to the carrier surface occurs during long term stirring in the development device, which may reduce the charging ability of carrier, and in the case of one-component developer, toner filming to the development roller or toner fusing to members (e.g., blade to form a thin toner film) occurs. When the volume-average particle diameter is greater than 8 μm or more, it becomes difficult to provide high-resolution, high-quality images, and variations in toner particle diameter may increase after developer consumption or developer supply.

The ratio of the volume-average particle diameter to the number-average particle diameter of the toner of the present invention is preferably 1.00 to 1.25, more preferably 1.05 to 1.25. When this ratio falls within this range, variations in toner particle diameter are small in the developer even after toner consumption and toner supply have been repeated for a long time, and in addition, even after a long time stirring in the development device, excellent developing ability can be ensured. Moreover, when this requirement is met in the case of one-component developer, variations in toner particle diameter decrease even after toner consumption or toner supply, and toner filming to the development roller and toner fusing to members (e.g., blade to form a thin toner film) are prevented, and in addition, even after long-time use of the development device (i.e., long-time stirring of developer), excellent developing ability can be ensured. Thus, high-quality images can be obtained. When the above ratio is greater than 1.25, it becomes difficult to provide high-resolution, high-quality images, and variations in toner particle diameter may increase after toner consumption or toner supply.

The ratio of the volume-average particle diameter to the number-average particle diameter of the toner of the present invention can be determined as follows with Multisizer III, a particle size analyzer manufactured by Beckman Coulter, Inc. At first, to 10-150 ml of an aqueous electrolyte solution (e.g., aqueous solution of sodium chloride (approximately 1 wt %)) is added 0.1-5 ml of surfactant (e.g., alkylbenzene sulfonate) as a dispersant. Subsequently, 2-20 mg of sample is added to the aqueous electrolyte solution. The aqueous electrolyte solution with suspended sample is then dispersed for 1-3 min with a ultrasonic disperser, and the volumes and numbers of toner particles are measured using a 100 μm-aperture to obtain a volume distribution and a number distribution. The volume-average particle diameter and number-average particle of toner can be found using these distributions.

The penetration of toner is preferably 15 mm or more, more preferably 20 mm to 30 mm. When the penetration is less than 15 mm, it may result in poor heat resistance/storage stability.

The penetration can be measured with a penetration test in accordance with JIS K2235-1991. More specifically, a 50-ml glass container is filled with toner and placed in a constant-temperature bath at 50° C. for 20 hours, and the toner is cooled to room temperature for penetration test. Note that greater values of penetration indicate higher heat resistance/storage stability.

The toner of the present invention preferably has a low minimum fixing temperature and a high offset-free temperature for the purpose of ensuring high low-temperature fixing ability and high offset resistance. To achieve this it is preferable that the minimum fixing temperature be less than 140° C. and that the offset-free temperature be 200° C. or more. As used herein, “minimum fixing temperature” means a lower limit of the fixing temperature at which 70% or more of image density remains after scrubbing the obtained image. As used herein, “offset-free temperature” means a temperature where no offset occurs and can be measured using an image forming apparatus designed such that development is effected using a given amount of toner.

Thermal characteristics of toner are also referred to as flow tester characteristics and evaluated in terms of softening point, flow start temperature, and softening point as measured by ½ method. These parameters can be measured with an appropriately selected method; for example, Flow Tester CFT500, an elevation-type flow tester manufactured by Shimadzu Corporation can be employed.

The softening point of the toner is preferably 30° C. or more, more preferably 50° C. to 90° C. When the softening point is less than 30° C., it may result in poor heat resistance/storage stability.

The flow start temperature of the toner of the present invention is preferably 60° C. or more, more preferably 80° C. to 120° C. When the flow start temperature is less than 60° C., at least one of heat resistance/storage stability and offset resistance may decrease.

The softening point of the toner of the present invention, as measured by ½ method, is preferably 90° C. or more, more preferably 100° C. to 170° C. When the softening point as measured by ½ method is less than 90° C., it may result in poor offset resistance.

The glass transition temperature of the toner of the present invention is preferably 40° C. to 70° C., more preferably 45° C. to 65° C. When the glass transition temperature is less than 40° C. or less, it may result in poor heat resistance/storage stability. When the glass transition temperature is greater than 70° C. or less, it may result in insufficient low-temperature fixing ability. The glass transition temperature can be measured for instance with DSC-60, a differential scanning calorimeter manufactured by Shimadzu Corporation.

The image density of image formed using the toner of the present invention is preferably 1.40 or more, more preferably 1.45 or more, and still more preferably 1.50 or more. When the image density is less than 1.40, the image density so low that it may result in failure to obtain high-quality images. The image density can be found in the following manner. Using a tandem-type color image forming apparatus (Imagio Neo 450, manufactured by Ricoh Company, Ltd.), a solid image with a developer deposition amount of 1.00±0.1 mg/cm² is printed onto copy paper (type 6200, manufactured by Ricoh Company, Ltd.) while setting the surface temperature of the fixing roller to 160° C.±2° C. Thereafter, the image densities of any given five points of the solid image are measured with X-Rite 938 Spectrodensitometer and averaged. In this way the average value is taken as the above image density.

### (Developer)

A developer of the present invention contains a toner of the present invention and may further contain additional ingredients such as carrier selected appropriately. Thus, the developer has excellent transferability, charging ability and is capable of stable formation of high-quality images. The developer may be a one-component developer or two-component developer and it is preferably a two-component developer for its long life when used in high-speed printers support for recent high information processing speed.

When the developer of the present invention is used as a one-component developer, variations in toner particle diameter decrease even after toner consumption or toner supply, and toner filming to the development roller and toner fusing to members (e.g., blade to form a thin toner film) are prevented, and in addition, even after long-time use of the development device (i.e., long-time stirring of developer), excellent developing ability can be ensured.

When the developer of the present invention is used as a two-component developer, even after a long-time toner consumption and toner supply, variations in toner particle diameter are small, and even after long-time stirring in the development device, excellent developing ability can be ensured.

The carrier can be selected appropriately depending on the intended purpose and it is preferably a carrier composed of a core material and a resin layer covering the core material.

The material of the core material is not specifically limited and can be selected from those known in the art. For example, it is preferable to employ manganese-strontium (Mn—Sr) material or manganese-magnesium (Mn—Mg) material (50 emu/g to 90 emu/g), preferably high magnetization material such as iron powder (10 emu/g or more) or magnetite (75 emu/g to 120 emu/g) for the purpose of securing image density. Moreover, it is preferably a low magnetization material such as copper-zinc (Cu—Zn) with 30 emu/g to 80 emu/g because the impact toward the photoconductor having a toner in the form of magnetic brush can be relieved and because it is advantageous for higher image quality. These materials may be used alone or in combination.

The volume-average particle diameter of the core material is preferably 10 μm to 150 μm, more preferably 40 μm to 100 μm. When the volume-average particle diameter is less than 10 μm, the amount of fine carrier powder increases, whereas magnetization per particle decreases and carrier scattering may occur. When the volume-average particle diameter is greater than 150 μm, the specific surface area decreases and thus toner scattering may occur; therefore, in the case of printing a full-color image composed with many solid portions, especially the reproduction of the solid portions may become insufficient.

The material of the resin layer is not specifically limited and can be appropriately selected from known resins depending on the intended purpose. Examples include, for example, amino resins, polyvinyl resins, polystyrene resins, halogenated polyolefins, polyester resins, polycarbonate resins, polyethylene, polyvinyl fluoride, polyvinylidene fluoride, polytrifluoroethylene, polyhexafluoropropylene, copolymers of vinylidene fluoride and acrylic monomer, copolymers of vinylidene fluoride and vinyl fluoride, fluoroterpolymers such as terpolymers of tetrafluoroethylene, vinylidene fluoride and non-fluoro monomer, and silicone resins. These may be used alone or in combination.

Examples of the amino resins include, for example, urea-formaldehyde resins, melamine resins, benzoguanamine resins, urea resins, polyamide resins, and epoxy resins. Examples of the polyvinyl resins include, for example, acrylic resins, polymethylmetacrylate, polyacrylonitrile, polyvinyl acetate, polyvinyl alcohol, and polyvinyl butyral. Specific examples of the polystyrene resins include, for example, polystyrene and styrene-acrylic copolymers. Examples of the halogenated polyolefins include, for example, polyvinyl chloride. Examples of the polyester resins include, for example, polyethyleneterephthalate and polybutyleneterephthalate.

The resin layer may contain conductive powder or the like as necessary; examples of the conductive powder include, for example, metal powder, carbon black, titanic oxide, tin oxide, and zinc oxide. The average particle diameter of these conductive powders is preferably 1 μm or less. If the average particle diameter is greater than 1 μm, it may be difficult to control the electrical resistance.

The resin layer may be formed by uniformly coating a surface of the core material with a coating solution containing silicone resin or the like dissolved in an solvent, by known coating method, followed by drying and baking. Examples of the coating method include, for example, dipping, spraying, and brushing. The solvent is not specifically limited and can be selected accordingly and examples thereof include, for example, toluene, xylene, methyl ethyl ketone, methyl isobutyl ketone, cellosolve, and butyl acetate.

The baking is not specifically limited and can be external heating or internal heating and examples of baking methods include, for example, methods using fixed electric furnace, fluid electric furnace, rotary electric furnace, or burner furnace, and methods using microwaves.

The resin layer amount of the carrier is preferably 0.01% by mass to 5.0% by mass. When the amount is less than 0.01% by mass, it may result in failure to uniformly form the layer over the surface of the core material, and when the amount is more than 5.0% by mass, the resin layer becomes so thick that fusing of carrier particles occur and thus equally-sized carrier particles may not be obtained.

The carrier content of two-component developer is preferably 90% by mass to 98% by mass, more preferably 93% by mass to 97% by mass.

The developer of the present invention can be used in a variety of image formation methods using known electrophotographic method, such as magnetic one-component developing method, non-magnetic one-component developing method, or two-component developing method.

### (Toner Container)

A toner container in the present invention contains therein the toner of the present invention, and encompasses a toner container containing the developer of the present invention.

The container for the toner container can be appropriately selected from those known in the art. Preferable examples thereof include, for example, those having a toner container body and a cap.

The size, shape, structure, material, etc., of the toner container body can be appropriately determined depending on the intended purpose. The shape is preferably a cylindrical shape, for example. It is particularly preferable that a spiral ridge be formed on the inner surface, wherein the spiral partly or entirely serves as a bellow; thereby the content or toner moves toward the discharging port when rotated.

The material of the toner container body is preferably made of material that offers good dimensional accuracy. For example, polyester resins, polyethylene, polypropylene, polystyrene, polyvinyl chloride, polyacrylic acid, polycarbonate resins, ABS resins, polyacetal resins are preferable.

The toner container is easy to be stored and delivered and has excellent handleability, as well as is preferably used with a process cartridge or an image forming apparatus by being detachably mounting thereto for toner supply.

### (Process Cartridge)

A process cartridge in the present invention includes at least a latent electrostatic image bearing member configured to bear a latent electrostatic image thereon, and a developing unit configured to develop the latent electrostatic image on the latent electrostatic image bearing member with a developer to form a visible image. The process cartridge further contains other units such as a charging unit, a transfer unit, a cleaning unit and a discharging unit as necessary.

The developing unit includes at least a developer storage for storing the aforementioned toner or developer of the present invention and a developer bearing member configured to hold and transfer the toner or developer stored in the developer storage, and may further include a layer thickness control member for controlling the thickness of toner layer formed on the developer bearing member.

The process cartridge can be detachably mounted to a variety of electrophotographic apparatuses, and is preferably detachably mounted to the image forming apparatus of the present invention, which will be described later.

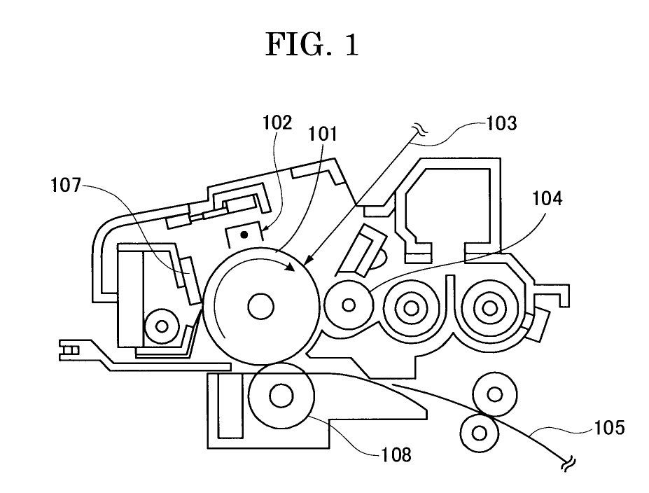

The process cartridge includes, for example, as shown in FIG. 1, a built-in photoconductor 101, a charging unit 102, a developing unit 104, a cleaning unit 107 and a transfer unit 108 and, where necessary, further includes additional units. In FIG. 1 reference numeral 103 denotes exposure by means of an exposure unit, and 105 denotes a recording medium.

Next, the image forming process by means of the process cartridge shown in FIG. 1 will be described. A latent electrostatic image corresponding to an exposed image is formed on the photoconductor 101 by charging using the charging unit 102 and exposing using exposure 103 of the exposure unit (not shown), with the photoconductor 101 being rotated in an arrow direction. The latent electrostatic image is developed using the toner by means of the developing unit 104 to form a visible image, which is then transferred to the recording medium 105 by means of the transfer unit 108 and printed out. The surface of the photoconductor 101 after image transfer is cleaned by means of the cleaning unit 107 followed charge elimination by means of a charge eliminating unit (not shown). The above operation is carried out repeatedly.

### (Image Forming Apparatus and Image Forming Method)

An image forming method of the present invention includes at least a latent electrostatic image forming step, a developing step, a transferring step and a fixing step, and further includes additional step(s) as necessary; examples include, for example, a charge eliminating step, a cleaning step, a recycling step, and a controlling step.

An image forming apparatus in the present invention includes at least a latent electrostatic image bearing member, a latent electrostatic image forming unit, a developing unit and a transfer unit, and further includes additional unit(s) as necessary; examples include, for example, a charge eliminating unit, a cleaning unit, a recycling unit, and a controlling unit.

The latent electrostatic image forming is a step of forming a latent electrostatic image on a latent electrostatic image bearing member.

The material, shape, structure, size, etc., of the latent electrostatic image bearing member (hereinafter may be referred to as “electrophotographic photoconductor”, “photoconductor”, or “image bearing member”) are not specifically limited and can be determined accordingly and it is preferably drum-shaped. The photoconductor is, for example, an inorganic photoconductor made of amorphous silicon, selenium or the like, or an organic photoconductor made of polysilane, phthalopolymethine, or the like. Amorphous silicon is preferred in order to achieve long life.

The latent electrostatic image formation is carried out, for example, by imagewise exposure of a surface of the latent electrostatic image bearing member right after uniformly charging the entire surface of the latent electrostatic image bearing member. This is performed by means of the latent electrostatic image forming unit. The latent electrostatic image forming unit includes at least a charging unit configured to uniformly charge the surface of the latent electrostatic image bearing member, and an exposure unit configured to imagewisely expose the surface of the latent electrostatic image bearing member.

The charging is carried out, for example, by applying voltage to the surface of the photoconductor by means of the charging unit. The charging unit is not specifically limited and can be appropriately selected depending on the intended purpose. The charging unit is not specifically limited; examples include, for example, conventional contact-charging units equipped with a conductive or semiconductive roller, blush, film or rubber blade, and conventional non-contact-charging units utilizing corona discharge such as corotron or scorotoron.

The exposure is carried out, for example, by imagewise exposure of the surface of the photoconductor by means of the exposure unit. The exposure unit is not specifically limited as long as predetermined imagewise exposure is possible on the surface of the latent electrostatic image bearing member that has been charged by the charging unit, and can be appropriately selected depending on the intended purpose. Examples of the exposure unit are various exposure units such as an optical copy unit, a rod-lens-array unit, an optical laser unit, an optical liquid crystal shatter unit, and the like

In the present invention, a backlight system may be applied for the exposure, in which imagewise-exposure is carried out from the back side of the photoconductor.

### —Developing and Developing Unit—

The developing is a step of forming a visible image by developing a latent electrostatic image using the toner or developer of the present invention.

The toner image formation may be performed by developing a latent electrostatic image using the toner or developer by means of the developing unit. The developing unit is not particularly limited and may be selected from known developing unit accordingly as long as it can perform developing using the toner or the developer. Preferred examples of the developing unit include, for example, a developing unit containing the toner and/or developer, and at least a developing device which can provide the toner or developer to the latent electrostatic image in a contact manner or non-contact manner. The developing device is preferably equipped with the toner container of the present invention.

The developing device may be of dry development type or wet development type and may be a developing device for single color or multicolor; a preferred is, for example, a developing device which has a stirrer for charging the toner or developer by friction stirring, and a rotatable magnet roller.

In the developing device, the toner and carrier are mixed and thereby the toner is electrically charged by friction and toner particles are retained in the form of magnetic brush on a surface of the rotating magnet roller. Since the magnet roller is positioned near the latent electrostatic image bearing member (photoconductor), some toner particles constructing the magnetic brush formed on the surface of the magnet roller move to the surface of the latent electrostatic image bearing member (photoconductor) by electric attraction, resulting in development of the latent electrostatic image to form a visible image on the surface of the latent electrostatic image bearing member (photoconductor).

The developer to be contained in the developing device is a developer containing the toner of the present invention, which may be a one-component developer or two-component developer. The toner contained in the developer is the toner of the present invention.

### —Transferring and Transfer Unit—

The transferring step is a step of transferring a visible image to a recording medium, and it preferably uses an intermediate transfer member so that a visible image is transferred primarily on the intermediate transfer member and then the visible image is transferred secondarily to the recording medium. More preferably, the transferring step consists of a first transferring step in which a visible image, formed using toner of two or more colors or preferably full-color toner, is transferred to the intermediate transfer member to form a complex image thereon, and a secondary transferring step in which the complex image is transferred to a recording medium.

The transferring step can be performed by charging the latent electrostatic image bearing member (photoconductor) by means of a transfer charging device, which is achieved by the transfer unit. A preferred embodiment of the transfer unit is that it includes a primary transfer unit in which a visible image is transferred to the intermediate transfer member to form a complex image thereon, and a secondary transfer unit in which the complex image is transferred to a recording medium.

The intermediate transfer member is not specifically limited and can be selected from known transfer members depending on the intended purpose; preferred examples include, for example, a transfer belt and a transfer roller.

The transfer unit (the primary transfer unit and secondary transfer unit) preferably includes at least a transfer device configured to transfer the visible image formed on the latent electrostatic image bearing member (photoconductor) to a recording medium by means of electrical charge. There may be only one transfer unit or may be two or more transfer units are used. Examples of the transfer device include, for example, a corona transfer device utilizing corona discharge, a transfer belt, a transfer roller, a pressure-transfer roller, and an adhesion-transfer device.

The recording medium is not specifically limited and can be appropriately selected from known recording media (recording paper sheets).

The fixing is a step of fixing the visible image transferred on a recording medium using a fixing device. The fixing step may be performed for each of the toner images having different colors when they are transferred to the recording medium, or may be performed at a time for laminated toner images.

The fixing device is not specifically limited and cab be appropriately selected depending on the intended purpose, with a preferred example being a conventional heating and pressurizing unit. The heating and pressurizing unit is, for example, a combination of a heating roller and a pressurizing roller, a combination of a heating roller, a pressurizing roller and an endless belt. In general, the heating temperature of the heating and pressurizing unit is preferably 80° C. to 200° C.

In the present invention, for example, a conventional photo-fixing device can be used along with or in place of the fixing step and fixing unit.

The charge eliminating step is a step of applying a charge-eliminating bias to the charged photoconductor for charge removal. This is suitably performed by the charge eliminating unit.

The charge eliminating unit is not specifically limited as long as a charge eliminating bias is applied to the charged photoconductor for charge removal, and can be appropriately selected from conventional charge eliminating depending on the intended purpose. A suitable example thereof is a charge eliminating lamp.

The cleaning step is a step of removing residual toner particles on the photoconductor. This is suitably performed by means of the cleaning unit. The cleaning unit is not specifically limited as long as such residual toner particles on the photoconductor can be removed, and can be appropriately selected from conventional cleaners depending on the intended purpose; examples include, for example, a magnetic blush cleaner, an electrostatic brush cleaner, a magnetic roller cleaner, a blade cleaner, a blush cleaner, and a wave cleaner.

The recycling step is a step of recycling toner collected in the cleaning step to the developing unit. This is suitably performed by means of the recycling unit.

The recycling unit is not specifically limited and can be appropriately selected from conventional conveyance systems.

The controlling is a step of controlling each of the aforementioned steps. This is suitably performed by means of the control unit.

The control unit is not specifically limited as long as it is capable of controlling the operation of each of the aforementioned units, and can be appropriately selected depending on the intended purpose; examples include, for example, such devices as sequencers and computers.

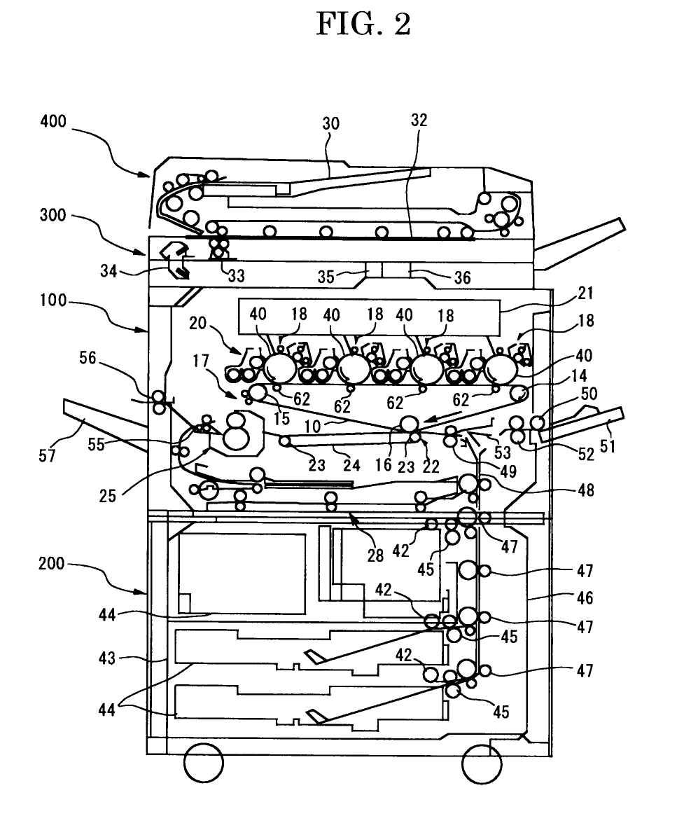

One embodiment of an image forming method of the present invention performed by an image forming apparatus of the present invention is described with reference to FIG. 2 below.

FIG. 2 is a schematic view showing the configuration of one embodiment according to an image forming apparatus of the present invention. In FIG. 2 reference numeral 100 denotes a copier main body, 200 denotes a paper feed table for supporting the copier main body 100, 300 denotes a scanner mounted on the copier main body 100, and 400 denotes an automatic document feeder (ADF) mounted on the scanner.

The copier main body 100 is provided with a tandem-type image forming apparatus 20 in which four image forming units 18 are linearly arranged, each having electrophotography process units (e.g., a charging unit, a developing unit, and cleaning unit) around a photoconductor 40, a latent electrostatic image bearing member. Above the tandem-type image forming apparatus 20, there is provided an exposure device 21 that forms a latent image by exposing the photoconductor 40 using a laser beam based on the image information. An intermediate transfer belt 10 formed of an endless belt member is arranged at a position facing the photoconductors 40 of the tandem-type image forming apparatus 20. Primary transfer units 62, which transfer respective toner images with different colors formed on their corresponding photoconductors 40, are provided across the intermediate transfer belt 10 from the photoconductors 40. Below the intermediate transfer belt 10 there is provided a secondary transfer device 22 that transfer the toner images, superimposed on the intermediate transfer belt 10, to a transfer sheet at a time that is delivered from the paper feed table 200. The secondary transfer device 22 is composed of a secondary transfer belt 24 (endless belt) stretched between two rollers 23 and is pressed against a supporting roller 16, with the intermediate transfer belt 10 placed between them. With this configuration the toner image on the intermediate transfer belt 10 is transferred onto a transfer paper sheet. Beside the secondary transfer device 22, there is provide a fixing device 25 that fixes the image to the transfer paper sheet. The fixing device 25 includes a press roller 252 pressed against a fixing belt 254 (endless belt).

The secondary transfer device 22 also has a sheet transfer function of transferring a printed transfer paper sheet to the fixing device 25. It is, of course, possible to arrange a transfer roller or non-contact type charger as the secondary transfer device 22. In this case, it is difficult for the secondary transfer device 22 to have such a sheet transfer function.

In the illustration, below the secondary transfer device 22 and fixing device 25, there is provided a reversing device 28 that flips over the transfer sheet for both-side printing. The developing device of the image forming unit 18 employs a developer containing the above toner. In the developing device a developer bearing member bears thereon the developer for delivery, and an alternating electric field is applied at a position facing the photoconductor 40 for the development a latent image formed thereon. Application of an alternating electric field activates the developer and thereby a narrower toner charge amount distribution can be obtained, increasing the developing ability.

In addition, it is possible to employ a process cartridge in which the photoconductor 40 and developing device are integrated together, which process cartridge being configured such that it is detachably mounted to the image forming apparatus main body. The process cartridge may further include a charging unit, and a cleaning unit.

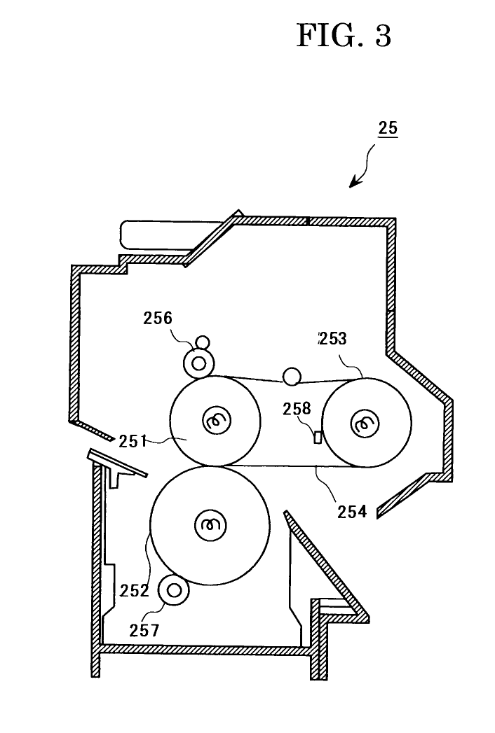

FIG. 3 is a schematic view showing one embodiment of a fixing device according to the present invention, with a fixing belt is mounted thereto. The fixing device 25 includes a heating roller 253, a fixing roller 251, a heating roller 252 as a pressing means that is pressed against the fixing roller 251, and a fixing belt 254 stretched between the heating roller 253 and fixing roller 251.

As with the fixing roller 251 and pressing roller 252 of the fixing device 25 shown in FIG. 3, the above fixing roller 251 and pressing roller 25 are each composed of a metallic core and an elastic layer that is made of heat-resistant elastic material and that covers the metallic core. The thickness of the elastic layer is adjusted appropriately. As a surface layer of the elastic layer, a releasing layer made of fluorine resin or the like is used in order to improve the releasing ability of transfer paper and toner. A halogen heater is provided inside the core. The pressing roller 253 is biased by a unillustrated pressing member (e.g., a spring) toward the fixing roller 251, deforming the elastic layer to form a nip portion between the fixing roller 251 and pressing roller 253, where toner is pressed and heated for a given time.

As a base of the fixing belt 254, an endless belt-shaped base made of heat-resistant resin or metal is used. As the heat-resistant resin for example, polyimide, polyamideimide, and polyether ether ketone are known. As the metal, for example, nickel, aluminum, and stainless steel are used. The base may be formed of layers of resin and metal. In particular, a belt composed of polyimide resin and electroformed nickel is preferable because it has high strength, elasticity, and durability. Preferably, the thickness is 10 μm or less. In order for the fixing belt 254 to be in press-contact with a transfer paper sheet and toner, the fixing belt 254 is composed of an elastic layer made of silicone rubber or the like that offers high releasing ability and of a heat-resistant releasing layer made of fluorine resin with low a low friction coefficient.

The heating roller 253 is a member for stretching and heating the fixing belt 254 wrapped around it. To achieve this the heating roller 253 includes therein a heat source such as a halogen lamp or a nichrome wire. The heating roller 253 is a thin, hollow cylindrical roller made of aluminum, carbon steel, or stainless steel. It is preferable to employ an 1-4 mm thick aluminum cylinder that has excellent heat conductivity, because temperature variations can be made small along the length of the roller. The surface of the heating roller 253 is anodized in order to avoid friction with respect to the fixing belt 254.

There is provided a temperature sensor 255 composed of a thermo couple, themistor or the like at a position across the fixing belt 254 from the heating roller 253 for the purpose of measuring the temperature of the circumferential surface of the fixing belt 254. In accordance with detection signals received from the temperature sensor, a temperature controller (not shown) controls the operation of the heater or the like in the heating roller 253.

Next, full-color image formation (color copying) with a tandem-type developing device 120 is described. At first, a document is placed on a document table 130 of an automatic document feeder (ADF) 400. Alternatively, the automatic document feeder 400 is opened, the document is placed onto a contact glass 32 of a scanner 300, and the automatic document feeder 400 is closed.

When a start switch (not shown) is pushed, a document, if any, placed on the automatic document feeder 400 is transferred onto the contact glass 32. When the document is initially placed on the contact glass 32, the scanner 300 is immediately driven to operate a first carriage 33 and a second carriage 34. Light is applied from a light source to the document, and reflected light from the document is further reflected toward the second carriage 34 at the first carriage 33. The reflected light is further reflected by a mirror of the second carriage 34 and passes through image-forming lens 35 into a read sensor 36 to thereby read the document.

When the start switch is pushed, a drive motor (not shown) drives one of support rollers 14, 15 and 16 to rotate, causing the other two support rollers to rotate by the rotation the driven support roller. In this way the intermediate transferring member 10 endlessly runs around the support rollers 14, 15 and 16.

Simultaneously, the individual image forming units 18 respectively rotate their photoconductors 40 to thereby form black, yellow, magenta, and cyan monochrome images on the photoconductors 40, respectively. With the conveying intermediate transferring member 10, the monochrome images are sequentially transferred to form a composite color image on the intermediate transfer 10.

Separately, when the start switch is pushed, one of feeder rollers 42 of the feeder table 200 is selectively rotated, sheets are ejected from one of multiple feeder cassettes 44 in a paper bank 43 and are separated in a separation roller 45 one by one into a feeder path 46, are transported by a transport roller 47 into a feeder path 48 in the copier main body 100 and are bumped against a resist roller 49.

Alternatively, pushing the start switch rotates a feeder roller 50 to eject sheets on a manual bypass tray 51, the sheets are separated one by one on a separation roller 52 into a manual bypass feeder path 53 and are bumped against the resist roller 49.

The resist roller 49 is rotated synchronously with the movement of the composite color image on the intermediate transferring member 10 to transport the sheet into between the intermediate transferring member 10 and the secondary transferring unit 22, and the composite color image is transferred onto the sheet by action of the secondary transferring unit 22 to thereby record a color image.

The sheet bearing the transferred image is transported by the secondary transferring unit 22 into the fixing unit 25, is given heat and pressure in the fixing unit 25 to fix the transferred image, changes its direction by action of a switch blade 55, and is ejected by an ejecting roller 56 to be stacked on an output tray 57.

Alternatively, the sheet changes its direction by action of the switch blade 55 into the sheet reverser 28, is flipped over therein, is transported again to the transfer position for image formation on the back surface of the sheet, and is ejected by the ejecting roller 56 to be stacked on the output tray 57.

After image transfer, an intermediate transfer cleaning device 17 removes residual toner particles on the intermediate transferring member 10 for another image formation by the tandem-type image forming apparatus 20.

The image forming apparatus, image forming method, and process cartridge according to the present invention use the toner of the present invention and thus can form brilliant image on standard paper as compared to offset printing.

### EXAMPLES

Hereinafter, Examples of the present invention will be described, which however shall not be construed as limiting the scope of the present invention in any way. Note in Examples that “part” and “%” are expressed on a weight basis, and that “mol” means mole ratio.

Acid value, amine value, melting point of wax, weight-average molecular weight of resin, and volume-average particle diameter of toner were measured as described below.

### <Measurement of Acid Value and Amine Value>

Specifically, acid value (AV) and amine value are measured in the following manner:

Measurement instrument: automatic potentiometric titrator DL-53 Titrator (Metller-Toledo International Inc.)

Electrode: DG113-SC (Metller-Toledo International Inc.)

Analysis software: LabX Light Version1.00.000

Calibration: mixture solvent of 120 ml toluene and 30 ml ethanol is used

Measurement temperature: 23° C.

Measurement conditions are as follows:

### Stir

Speed[%] 25

Time[s] 15

EQP titration

Titrant/Sensor

Titrant CH₃ONa

Concentration[mol/L] 0.1

Sensor DG115
Unit of measurement mV
Predispensing to volume
   Volume[mL] 1.0
Wait time[s] 0

Titrant addition Dynamic
dE(set)[mV] 8.0
dV(min)[mL] 0.03
dV(max)[mL] 0.5

Measure mode Equilibrium controlled
dE[mV] 0.5
dt[s] 1.0
t(min)[s] 2.0
t(max)[s] 20.0

Recognition
Threshold100.0

Steepest jump only No
Range No
Tendency None

Termination
At maximum volume[mL] 10.0
At potential No
At slope No
After number EQPs Yes
n=1
comb. Termination conditions No

Evaluation
Procedure Standard
Potential 1 No
Potential 2 No
Stop for reevaluation No

### —Measurement Method of Acid Value—

Avid value measurement was made in accordance with the method described in JIS K0070-1992 as follows:

Sample preparation: 0.5 g of toner was added to 120 ml of toluene and dissolved by stirring for about 10 hours at room temperature (23° C.), and 30 ml of ethanol was added to prepare a sample solution. The acid value can be measured using the above-mentioned instrument. However, the acid value was obtained as follows:

The sample solution was titrated with N/10 (0.1M) potassium hydroxide solution and alcohol solution previously standardized. Based on the consumption amounts of the alcohol solution and potassium hydroxide solution, the amine value was calculated using the following equation:

Acid value=KOH(mol)×N×56.1/sample mass(where N is a factor of N/10 KOH)

### —Measurement Method of Amine Value—

Sample preparation: 0.5 g of toner was added to 120 ml of toluene and dissolved by stirring for about 10 hours at room temperature (23° C.), and 30 ml of ethanol was added to prepare a sample solution. The amine value can be measured using the above-mentioned instrument However, the amine value was obtained as follows:

The sample solution was titrated with N/10 (0.1M) hydrochloric acid solution and alcohol solution previously standardized, and the amine value was calculated based on the consumption amounts of the hydrochloric acid solution and alcohol solution.

### <Measurement of Softening Point (Tm) of Wax>

The softening point (Tm) of wax is measured by differential scanning calorimetry (DSC) and found as a peak top of the DSC curve where a maximum heat absorption is observed. Measurement was made under the following conditions using TA-60WS and DSC-60, manufactured by Shimadzu Corporation.

### —Measurement Conditions—

Sample container: aluminum sample pan (with lid)

Sample amount: 5 mg

Reference: aluminum sample pan (10 mg of alumina)

Atmosphere: nitrogen (flow rate: 50 ml/min)

### Temperature Conditions

Start temperature: 20

Heating rate: 10° C./min

Finish temperature: 150° C.

Retention time: NO

Heating rate: 10° C./min

Finish temperature: 20° C.

Retention time: NO

Heating rate: 10° C./min

Finish temperature: 150° C.

Analysis was carried out on data analysis software TA-60 version1.52 (Shimadzu Corporation). Analysis procedure is as follows: Using the peak analysis function of the software, a segment of the DrDSC curve (differential DSC curve at the second heating), which segment corresponds to a temperature range of within ±5° C. from the maximum peak, is specified for determination of the peak temperature. Subsequently, using the peak analysis function, the maximum heat absorption temperature is found from the DSC curve in a range within ±5° C. of the peak temperature. The obtained temperature corresponds to the melting point (Tm) of wax.

### <Measurement of Weight-Average Molecular Weight of Resin>

Gel permeation chromatography (GPC) device: GPC-8220GPC (TOSOH CORPORATION)

Column: TSKgel SuperHZM-H; 15 cm, 3 channel (TOSOH CORPORATION)

Temperature: 40° C.

Solvent: THF

Flow rate: 0.35 ml/min

GPC sample: 0.4 ml sample (0.15% conc.)

Pre-treatment of sample: Toner is dissolved in stabilizer-containing THF (Wako Pure Chemical Industries, Ltd.) to a concentration of 0.15%, and the solution is filtrated through a 0.2 μm-pore filter. The flow-through is used as sample.

GPC is performed by injecting 100 μl of the THF sample solution in the column. For the molecular weight measurement of the sample, the molecular weight distribution of the sample was measured based on the relationship between the logarithm values of the calibration curve prepared from several monodispersed polystyrene standard samples and counts.

As the standard polystyrene samples for the preparation of the calibration curve, Shodex STANDARD series (Std. No. S-7300, S-210, S-390, S-875, S-1980, S-10.9, S-629, S-3.0, S-0.580, by SHOWA DENKO K.K.) and toluene were employed. A refractive index (RI) detector was used as a detector.

### <Measurement of Volume-Average Particle Diameter of Toner>

The volume-average particle diameter (Dv) of toner was measured by a particle size analyzer (Multisizer III, manufactured by Beckman Coulter, Inc.) at an aperture diameter of 100 μm using analysis software (Beckman Coulter Multisizer 3 Version3.51) More specifically, 0.5 ml of 10% surfactant (NEOGEN, alkylbenzenesolfonate, manufactured by Dai-ichi Kogyo Seiyaku Co., Ltd.) was placed in a 100-ml glass beaker, 0.5 g of each toner was added in the beaker and mixed together using a microspatula, and 80 ml of ion-exchange water was added. The resultant dispersion liquid was subjected to dispersing treatment for 10 min with W-113MK-II, a ultrasonic disperser manufactured by HONDA ELECTRONICS Co., Ltd. For analysis, the aforementioned Multisizer III was used and ISOTON III (Beckman Coulter Inc.) was used as a measurement sample. In the measurement the toner sample dispersion liquid was dropped so that the concentration indicated by the device is 8±2%. It is important to keep the concentration within 8±2% in view of the reproducibility of particle size measurement. In this concentration range there would be no error in the measured particle size.

### Synthesis Example 1

### Preparation of Pigment Dispersant A

A 500 ml four-necked separable flask equipped with a stirrer, dropping funnel, gas inlet tube and thermometer was charged with 4 parts of bisphenol A ethyleneoxide adduct, 10 parts of dibuthylolbutanoic acid, 44 parts of N,N-bis(2-hydroxypropyl)aniline and 60 parts of methyl ethyl ketone, and the flask was purged with dry nitrogen gas and heated to 80° C. with stirring. Under stirring 62 parts of isophorone diisocyanate was added dropwise to the flask over 10 minutes, and reacted for 6 hours. The reaction product was cooled to 65° C., and 319 parts of water and 11 parts of 25% ammonia water were added to the flask, and the flask was heated to remove solvents, i.e., 60 parts of methyl ethyl ketone and 330 parts of alkaline water. In this way pigment dispersant A having a melting point of 65° C., acid value of 31 mgKOH/g and amine value of 25 mgKOH/g was prepared.

### Synthesis Examples 2 to 13

### Preparation of Pigment Dispersants B to M

Pigment dispersants B to M were prepared as in Synthesis Example 1 except that the added amounts of ingredients were changed as shown in Table 1.

The acid values, amine values, and melting points of pigment dispersants B to M are summarized in Table 1.

TABLE 1

| | Pigment disperants | | | | | | | | | | | | |
|---|---|---|---|---|---|---|---|---|---|---|---|---|---|
| | A | B | C | D | E | F | G | H | I | J | K | L | M |
| Bisphenol A ethylene oxide adduct | 4 | 2 | 2 | 2 | 2 | 2 | 2 | 2 | 2 | 2 | 2 | 2 | 2 |
| Dibuthylolbutanoic acid | 10 | 8 | 11 | 20 | 9 | 16 | 15 | 3 | 30 | 16 | 16 | 16 | 27 |
| N,N-bis(2-hydroxypropyl)aniline | 44 | 38 | 38 | 46 | 38 | 51 | 0 | 35 | 40 | 55 | 62 | 14 | 55 |
| 1,6-Hexanediol | 0 | 0 | 0 | 0 | 0 | 0 | 95 | 0 | 0 | 0 | 0 | 0 | 0 |
| Isophorone diisocyanate | 62 | 62 | 62 | 62 | 62 | 62 | 58 | 55 | 62 | 62 | 62 | 62 | 55 |
| Acid value [mgKOH/g] | 31 | 22 | 27 | 48 | 25 | 35 | 32 | 15 | 55 | 30 | 25 | 22 | 53 |
| Amine value [mgKOH/g] | 25 | 27 | 24 | 28 | 20 | 42 | 25 | 22 | 20 | 45 | 52 | — | 17 |
| Melting point [° C.] | 65 | 52 | 67 | 35 | 45 | 52 | 46 | 48 | 38 | 55 | 47 | 71 | 62 |

### Synthesis Example 14

### Preparation of Unmodified Polyester Resin A

A reaction vessel equipped with a reflux condenser, stirrer and gas inlet tube was charged with 229 parts of bisphenol A ethyleneoxide (2 mol) adduct, 529 parts of bisphenol A propyleneoxide (3 mol) adduct, 208 parts of terephthalic acid, 46 parts of adipic acid and 2 parts of dibutyltin oxide, and reacted for 8 hours at 230° C. under normal pressure. After 5-hour reaction under reduced pressure (10-15 mmHg), 44 parts of trimellitic anhydride was added and reacted for 2 hours at 180° C. under normal pressure to produce unmodified polyester resin A.

Unmodified polyester resin A thus obtained had a number-average molecular weight of 2,500, weight-average molecular weight of 6,700, glass transition temperature of 44° C., and acid value of 25 mgKOH/g.

### Production Example 1

### Preparation of Copper Phthalocyanine

A reactor was charged with 1,218 parts of phthalic anhydride, 1,540 parts of urea, 200 parts of anhydrous copper (II) chloride, 5 parts of ammonium molybdate and as a solvent 4,000 parts of a mixture of alkylbenzens with alkyl groups of 5 to 8 carbon atoms. After heating to 200° C. with stirring, reaction was effected for 2.5 hours at that temperature. After completion of reaction, the solvent was removed under reduced pressure and the resulting product was added in 8,000 parts of 2% hydrochloric acid and stirred for 1 hour at 70° C., followed by suction filtration. The filtration cake thus obtained was then thoroughly washed with warmed water (80° C.) and dried to produce crude copper phthalocyanine. Subsequently, 500 parts of crude copper phthalocyanine was charged in ATTRITOR (5 litter volume, containing 13 kg of ⅜ inch-diameter steel balls) for pulverization at the inner temperature of 90° C. to 110° C. for 60 minutes, producing a mixture consisting of 71% α-type copper phthalocyanine and 29% β-type copper phthalocyanine.

The mixture was heated for 8 hours in a IL-flask together with 300 parts of isobutanol and 600 parts of water at the azeotropic temperature, and the solvent was completely removed by azeotropic distillation. Solids obtained by filtration of the recovered product were dried to produce copper phthalocyanine pigment, which was found to be β-type copper phthalocyanine pigment by X-ray diffraction analysis of its crystals.

### Production Example 2

### Preparation of Aluminum Phthalocyanine

A glass autoclave reactor was charged with 74.1 parts of phthalic anhydride, 120.1 parts of urea, 1 part of ammonium molybdate and 220 parts of “HISOL P” (an organic solvent available from Nippon Petrochemical Co., Ltd.), and heated to 150° C. with stirring. The pressure inside the reactor, raised due to the generation of gas, was adjusted to 3.5 kg/cm². At the time when the temperature of the reaction solution reached 150° C., the inner pressure was returned to normal pressure, and 16.7 parts of aluminum chloride and 1.5 parts of ammonium dihydrogen phosphate were added in the reactor together with a small amount of “HISOL P.” While keeping heating, reaction was effected for 5 hours at 220° C. under pressure (3.5 kg/cm²). After solvent removal by vacuum distillation, the residual product was deflocculated in 1,500 parts of methanol, stirred for 1 hour at 25° C., and filtrated. The obtained cake was then deflocculated in 1,500 parts of 2% caustic soda, washed for 1 hour at 80° C., deflocculated in 1,500 parts of 1% hydrochloric acid, washed for 1 hour at 70° C., deflocculated in 1,500 parts of water, washed for 1 hour at 70° C., and dried at 90° C. to produce 64.4 parts of a blue solid of aluminum phthalocyanine.

### Production Example 3

### Preparation of Copper Phthalocyanine Crude

A reactor was charged with 1,218 parts of phthalic anhydride, 1,540 parts of urea, 200 parts of anhydrous copper (II) chloride, 5 parts of ammonium molybdate and as a solvent 4,000 parts of a mixture of alkylbenzens with alkyl groups of 5 to 8 carbon atoms. After heating to 200° C. with stirring, reaction was effected for 2.5 hours at that temperature. After completion of reaction, the solvent was removed under reduced pressure and the resulting product was added in 8,000 parts of 2% hydrochloric acid and stirred for 1 hour at 70° C., followed by suction filtration. The filtration cake thus obtained was then thoroughly washed with warmed water (80° C.) and dried to produce a copper phthalocyanine crude.

### Production Example 4

### Preparation of Aluminum Phthalocyanine Crude

A glass autoclave reactor was charged with 74.1 parts of phthalic anhydride, 120.1 parts of urea, 1 part of ammonium molybdate and 220 parts of “HISOL P” (an organic solvent available from Nippon Petrochemical Co., Ltd.), and heated to 150° C. with stirring. The pressure inside the reactor, raised due to the generation of gas, was adjusted to 3.5 kg/cm². At the time when the temperature of the reaction solution reached 150° C., the inner pressure was returned to normal pressure, and 16.7 parts of aluminum chloride and 1.5 parts of ammonium dihydrogen phosphate were added in the reactor together with a small amount of “HISOL P.” While keeping heating, reaction was effected for 5 hours at 220° C. under pressure (3.5 kg/cm²). After solvent removal by vacuum distillation, the residual product was deflocculated in 1,500 parts of methanol, stirred for 1 hour at 25° C., and filtrated. The obtained cake was then deflocculated in 1,500 parts of 2% caustic soda, washed for 1 hour at 80° C., deflocculated in 1,500 parts of 1% hydrochloric acid, washed for 1 hour at 70° C., deflocculated in 1,500 parts of water, and washed for 1 hour at 70° C. to produce an aluminum phthalocyanine crude.

### Production Example 5

### Solvent Salt Milling

A dual-screw kneader was charged with 0.6 parts of the copper phthalocyanine crude prepared in Production Example 3, 0.4 parts of the aluminum phthalocyanine crude prepared in Production Example 4, 10 parts of pulverized sodium chloride, 1 part of diethylene glycol and 0.05 parts of a copper phthalocyanine phthalimidomethyl derivative, kneading them for 10 hours at 80° C. to 90° C. The kneaded product was added in 100 parts of 1% hydrochloric acid aqueous solution (80° C.) and stirred for 1 hour, followed by filtration, washing with warm water, drying, and pulverization to produce a mixture of copper phthalocyanine pigment and aluminum copper phthalocyanine pigment.

### (Examples of Toners Prepared by Aqueous Granulation)

### Example 1-1

### Preparation of Pigment Dispersion Liquid A

A vessel with a stirring bar therein was charged with 250 parts of unmodified polyester resin A, 100 parts of pigment dispersant A, and 1,625 parts of ethyl acetate, and stirred until unmodified polyester resin was dissolved. Next, 100 parts of the copper phthalocyanine pigment and 150 parts of the aluminum phthalocyanine pigment were added in the vessel and stirred for 1 hour to produce a mixed pigment solution.

The mixed pigment solution was placed in Ultraviscomill, a beads mill manufactured by Aimex K.K., 0.3 mm-diameter zirconia beads were loaded in the mill in a proportion of 80% by volume, and 5-pass operation was carried out, with the liquid feed rate being 1 kg/h and disk circumferential speed being 8 m/sec. In this way pigment dispersion liquid A was prepared.

### —Preparation of Raw Material Solution—

A reaction vessel equipped with a stirring bar and thermometer was charged with 378 parts of unmodified polyester resin A, 110 parts of carnauba wax, 22 parts of salicylic acid metal complex E-84 (Orient Chemical Co., Ltd.) and 947 parts of ethyl acetate, heated to 80° C. with stirring, retained for 5 hours at 80° C., and cooled to 30° C. over 1 hour to produce a raw material solution.

The raw material solution was placed in Ultraviscomill, a beads mill manufactured by Aimex K.K., 0.5 mm-diameter zirconia beads were loaded in the mill in a proportion of 80% by volume, and 3-pass operation was carried out, with the liquid feed rate being 1 kg/h and disk circumferential speed being 6 m/sec. In this way the carnauba wax was dispersed and thereby a wax dispersion liquid was prepared.

To 1,324 parts of 65% ethyl acetate solution of unmodified polyester resin A was added the wax dispersion liquid and 290 parts of pigment dispersion liquid A, and stirred for 30 minutes with T.K. HOMODISPER (Tokushu Kika Kogyo Co., Ltd.) to produce a tone material dispersion liquid.

A reaction vessel equipped with a reflux condenser, stirrer and gas inlet tube was charged with 682 parts of bisphenol A ethyleneoxide (2 mol) adduct, 81 parts of bisphenol A propyleneoxide (2 mol) adduct, 283 parts of terephthalic acid, 22 parts of trimellitic acid and 2 parts of dibutyltin oxide, and reacted for 8 hours at 230° C. under normal pressure, and then reacted under reduced pressure (10 to 15 mmHg) for 5 hours to produce an intermediate polyester resin.

The intermediate polyester resin had a number-average molecular weight of 2,100, weight-average molecular weight of 9,500, glass transition temperature of 55° C., acid value of 0.5 mgKOH/g, and hydroxyl group value of 51 mgKOH/g.

Next, a reaction vessel equipped with a reflux condenser, stirrer and nitrogen inlet tube was charged with 410 parts of the intermediate polyester resin, 89 parts of isophorone diisocyanate and 500 parts of ethyl acetate, and reacted for 5 hours at 100° C. to produce a prepolymer. The free isocyanate content of the prepolymer was 1.53%.

A reaction vessel equipped with a stirring bar and thermometer was charged with 170 parts of isophorone diamine and 75 parts of methyl ethyl ketone, and reacted for 5 hours at 50° C. to produce a ketimine compound. The ketimine compound had an amine value of 418 mgKOH/g.

In a reaction vessel, 749 parts of the toner material dispersion liquid, 115 parts of the prepolymer and 2.9 parts of the ketimine compound were placed, and mixed using TK HOMOMIXER (Tokushu Kika Kogyo Co., Ltd) at 5,000 rpm for 1 minute to prepare an oil phase mixture solution.

In a reaction vessel equipped with a stirring bar and thermometer, 683 parts of water, 11 parts of ELEMINOL RS-30 (a reactive emulsifier available from Sanyo Chemical Industries, Ltd.; sodium salt of sulfate of ethylene oxide adduct of methacrylic acid), 83 parts of styrene, 83 parts of methacrylic acid, 110 parts of butyl acrylate, and 1 part of ammonium persulfate were placed, and stirred at 400 rpm for 15 minutes to produce an emulsion liquid.

The emulsion liquid was heated to 75° C. and reacted for 5 hours. Subsequently, 30 parts of a 1 wt % aqueous solution of ammonium persulfate was added, and maturation was effected at 75° C. for 5 hours to prepare a resin particle dispersion liquid.

Water (990 parts), 83 parts of the resin particle dispersion liquid, 37 parts of ELEMINOL MON-7 (available from Sanyo Chemical Industries, Ltd.), a 48.5 wt % aqueous solution of dodecyldiphenyl ether sodium disulfonate, 135 parts of SEROGEN BS-H-3 (available from Dai-ichi Kogyo Seiyaku Co., Ltd.), an aqueous solution of 1 wt % of sodium carboxymethylcellulose (polymer dispersant), and 90 parts of ethyl acetate were mixed and stirred to produce an aqueous medium.

The oil phase mixture solution (867 parts) was added to 1,200 parts of the aqueous medium, and mixed using TK HOMOMIXER for 20 minutes at 3,000 rpm to prepare a dispersion liquid (emulsion slurry).

Subsequently, in a reaction vessel equipped with a stirrer bar and thermometer, the emulsion slurry was placed, solvent removal was carried out at 30° C. for 8 hours, and maturation was effected at 45° C. for 4 hours to produce a dispersion slurry.

After filtration of 100 parts of the dispersion slurry under reduced pressure, 100 parts of ion-exchange water was added to the filtration cake, and mixed at 12,000 rpm using TK HOMOMIXER for 10 minutes, followed by filtration.

Hydrochloric acid (10 wt %) was added to the resultant filtration cake to adjust its pH to 2.8, and mixed at 12,000 rpm using TK HOMOMIXER for 10 minutes, followed by filtration. Ion-exchange water (300 parts) was then added to the further resultant filtration cake, and mixed at 12,000 rpm using TK HOMOMIXER for 10 minutes. This procedure was repeated to obtain a final filtration cake.

The resultant final filtration cake was dried with a circular air-drier at 45° C. for 48 hours, and sieved with a mesh with openings of 75 μm to produce toner base particles. The toner base particles had a volume-average particle diameter of 5.7 μm.

Hydrophobic silica (1.0 part) and hydrophobic titanium oxide (0.5 parts) as external additives were added to 100 parts of the resultant toner base particles, and mixed using HENSCHEL MIXER (Mitsui Mining Co., Ltd.) to produce toner 1-1.

### Example 1-2

### Preparation of Toner 1-2

Toner 1-2 was prepared as in Example 1-1 except that pigment dispersant B was used in place of pigment dispersant A.

### Example 1-3

### Preparation of Toner 1-3

Toner 1-3 was prepared as in Example 1-1 except that pigment dispersant C was used in place of pigment dispersant A.

### Example 1-4

### Preparation of Toner 1-4

Toner 1-4 was prepared as in Example 1-1 except that pigment dispersant D was used in place of pigment dispersant A.

### Example 1-5

### Preparation of Toner 1-5

Toner 1-5 was prepared as in Example 1-1 except that pigment dispersant E was used in place of pigment dispersant A.

### Example 1-6

### Preparation of Toner 1-6

Toner 1-6 was prepared as in Example 1-1 except that pigment dispersant F was used in place of pigment dispersant A.

### Example 1-7

### Preparation of Toner 1-7

Toner 1-7 was prepared as in Example 1-1 except that pigment dispersant G was used in place of pigment dispersant A.

### Example 1-8

### Preparation of Toner 1-8

Toner 1-8 was prepared as in Example 1-1 except that the added amount of copper phthalocyanine pigment was changed from 100 parts to 175 parts and that the added amount of aluminum phthalocyanine pigment was changed from 150 parts to 75 parts.

### Example 1-9

### Preparation of toner 1-9

Toner 1-9 was prepared as in Example 1-1 except that the added amount of copper phthalocyanine pigment was changed from 100 parts to 225 parts and that the added amount of aluminum phthalocyanine pigment was changed from 150 parts to 25 parts.

### Comparative Example 1-1

### Preparation of Toner 1-10

Toner 1-10 was prepared as in Example 1-1 except that pigment dispersant H was used in place of pigment dispersant A.

### Comparative Example 1-2

### Preparation of Toner 1-11

Toner 1-11 was prepared as in Example 1-1 except that pigment dispersant I was used in place of pigment dispersant A.

### Comparative Example 1-3

### Preparation of Toner 1-12

Toner 1-12 was prepared as in Example 1-1 except that pigment dispersant J was used in place of pigment dispersant A.

### Comparative Example 1-4

### Preparation of Toner 1-13

Toner 1-13 was prepared as in Example 1-1 except that pigment dispersant K was used in place of pigment dispersant A.

### Comparative Example 1-5

### Preparation of Toner 1-14

Toner 1-14 was prepared as in Example 1-1 except that pigment dispersant L was used in place of pigment dispersant A.

### Comparative Example 1-6

### Preparation of Toner 1-15

Toner 1-15 was prepared as in Example 1-1 except that pigment dispersant M was used in place of pigment dispersant A.

### Comparative Example 1-7

### Preparation of Toner 1-16

Toner 1-16 was prepared as in Example 1-1 except that the added amount of copper phthalocyanine pigment was changed from 100 parts to 250 parts and that no aluminum phthalocyanine pigment was used.

### Comparative Example 1-8

### Preparation of toner 1-17

Toner 1-17 was prepared as in Example 1-1 except that pigment dispersant A was not used.

### Comparative Example 1-9

### Preparation of Toner 1-18

Toner 1-18 was prepared as in Example 1-1 except that pigment dispersant A was changed to the pigment dispersion liquid prepared below.

### —Preparation Example of Pigment Dispersion Liquid—

Water (1,200 parts), 216 parts of the copper phthalocyanine pigment, 324 parts of the aluminum phthalocyanine pigment, and 540 parts of the unmodified polyester resin were mixed using HENSCHEL MIXER (Mitsui Mining Co., Ltd.). The resultant mixture was kneaded with a two-roll mill at 150° C. for 30 minutes, pressure-stretched, cooled, and pulverized with a pulverizer (Hosokawa Micron Corporation) to prepare a masterbatch.

The masterbatch (500 parts) and 1,625 parts of ethyl acetate were mixed and stirred until dissolved to prepare a pigment dispersion liquid.

### (Examples of Pulverization Toners)

### Example 2-1

### Preparation of Toner 2-1

The following materials were thoroughly mixed in HENSCHEL MIXER and melted by heating at 100° C. to 110° C. for 30 minutes using a roll mill. After cooled to room temperature, the resultant kneaded product was pulverized with a jet mill and classified with a wind classifier to produce toner base particles. To 100 parts of the toner base particles was added 1.0 part of silica (R974, available from Nippon Aerosil Co, Ltd.) and 0.5 parts of titania (T805, available from Nippon Aerosil Co, Ltd.), and mixed with HENSCHEL MIXER. Coarse particles were then removed using a mesh to produce toner 2-1.

### —Toner Composition—

Polyester resin (weight-average molecular weight=7,000, melting point (Tm)=110° C., acid value=25 mgKOH/g) . . . 90 parts

Polyester resin (weight-average molecular weight=80,000, melting point (Tm)=143° C., acid value=20 mgKOH/g) . . . 10 parts

Carnauba wax (WA-05, available from CERARICA NODA Co., Ltd., melting point=79° C.) . . . 5 parts

Charge control agent (TN-105, available from HODOGAYA CHEMICAL CO., LTD.) . . . 3 parts

Copper phthalocyanine (Production Example 1) . . . 2.5 parts

Aluminum phthalocyanine (Production Example 2) . . . 3.5 parts

Pigment dispersant A . . . 1 part

### Comparative Example 2-1

### Preparation of Toner 2-2

Toner 2-2 was prepared as in Example 2-1 except that pigment dispersant A was not added.

### (Evaluation of Color Characteristics)

A modified tandem-type image forming apparatus (Imagio Neo 450, available from Ricoh Company, Ltd.) in which the belt-heating fixing device shown in FIG. 3 is mounted was used for evaluation of color characteristics. In the fixing device, the belt in the consists of a 100 μm-thick base made of polyimide, a 100 μm-thick elastic intermediate layer made of silicone rubber, and as a surface layer a 15 μm-thick offset preventing layer made of PFA; the fixing roller is formed of a silicone foam; the pressing roller is formed of a 1 mm-thick metal cylinder made of SUS; the offset preventing layer of the pressing roller is 2 mm thick and formed of PFA tube plus silicone rubber; the heating roller is 2 mm thick and made of aluminum; and the surface pressure is 1×10⁵ Pa.

For the preparation of a toner fixed image, Ricoh full-color PPC sheet (TYPE6000<70W>, a A4 sheet made with a grain direction, available from Ricoh Company, Ltd.) was employed. Evaluation was carried out with the toner deposition amount being 0.3 mg/cm² and fixing temperature being 160° C. The toner fixed image had a 60° glossiness of 5-15.

### —Evaluation of Color Reproducibility (Color Saturation) and Color Difference—

The obtained toner fixed image was evaluated for color reproducibility (saturation). CIE L*a*b* measurements were made for the toner fixed image. More specifically, measurements were made in accordance with ISO/CD13655 using X-Rite 938 Spectrodensitometer (light source: CIE-D65). The results are summarized in Table 2-2.

The color difference based on CIE Lab system was calculated using the following Equation (1) (JIS Z8730), and saturation based on CIE Lab system was calculated using the following Equation (2) (JIS Z8729). The results are summarized in Table 2-2.

ΔE*ab=[(ΔL*)²+(Δa*)²+(Δb*)²]^{1/2} Equation (1)

where ΔE*ab designates the color difference based on CIE L*a*b* system, ΔL* designates the difference of CIE brightness L* in non-reached object color based on CIE L*a*b* system specified in JIS Z8729, and Δa* and Δb* respectively designate the difference of a* and b* (color axes) in the non-reached object color based on CIE L*a*b* system. For standard colors, art paper standard colors described in the instruction manual of “ISO/JAPAN COLOR—Color Reproduction & Printing 2001” for sheet-fed offset printing, were employed. In general, if the difference of the value of ΔE*ab is 3 or greater, color difference is visually recognized.

C*ab=[(a*)²+(b*)²]^{1/2} Equation (2)

### —Coloring Ability of Toner—

For the evaluation of the coloring ability of toner, the image density of the fixed image was measured using X-Rite 938 Spectrodensitometer (light source: CIE-D65). The results are summarized in Table 2-2.

TABLE 2-1

| | | Mixing ratio (wt %) | | |
|---|---|---|---|---|
| | | Copper | Aluminum | Type of |
| | | phthalocyanine | phthalocyanine | pigment |
| | Toner No. | pigment | pigment | dispersant |
| Ex. 1-1 | 1-1 | 40 | 60 | A |
| Ex. 1-2 | 1-2 | 40 | 60 | B |
| Ex. 1-3 | 1-3 | 40 | 60 | C |
| Ex. 1-4 | 1-4 | 40 | 60 | D |
| Ex. 1-5 | 1-5 | 40 | 60 | E |
| Ex. 1-6 | 1-6 | 40 | 60 | F |
| Ex. 1-7 | 1-7 | 40 | 60 | G |
| Ex. 1-8 | 1-8 | 70 | 30 | A |
| Ex. 1-9 | 1-9 | 90 | 10 | A |
| Comp. Ex. 1-1 | 1-10 | 40 | 60 | H |
| Comp. Ex. 1-2 | 1-11 | 40 | 60 | I |
| Comp. Ex. 1-3 | 1-12 | 40 | 60 | J |
| Comp. Ex. 1-4 | 1-13 | 40 | 60 | K |
| Comp. Ex. 1-5 | 1-14 | 40 | 60 | L |
| Comp. Ex. 1-6 | 1-15 | 40 | 60 | M |
| Comp. Ex. 1-7 | 1-16 | 100 | 0 | A |
| Comp. Ex. 1-8 | 1-17 | 40 | 60 | — |
| Comp. Ex. 1-9 | 1-18 | 40 | 60 | — |
| Ex. 2-1 | 2-1 | 40 | 60 | A |
| Comp. Ex. 2-1 | 2-2 | 40 | 60 | — |

TABLE 2-2

| | | | Coloring | | Overall |
|---|---|---|---|---|---|
| | Toner No. | Saturation | ability | ΔE*ab | Evaluation |
| Ex. 1-1 | 1-1 | 62.2 | 1.41 | 0.5 | 4 |
| Ex. 1-2 | 1-2 | 57.2 | 1.38 | 4.8 | 3 |
| Ex. 1-3 | 1-3 | 59.3 | 1.41 | 3.5 | 3 |
| Ex. 1-4 | 1-4 | 65.2 | 1.45 | 0.4 | 5 |
| Ex. 1-5 | 1-5 | 58.3 | 1.39 | 4.3 | 3 |
| Ex. 1-6 | 1-6 | 61.9 | 1.43 | 0.8 | 4 |
| Ex. 1-7 | 1-7 | 61.5 | 1.42 | 0.4 | 4 |
| Ex. 1-8 | 1-8 | 63.7 | 1.44 | 1.7 | 5 |
| Ex. 1-9 | 1-9 | 66.1 | 1.42 | 2.8 | 5 |
| Comp. Ex. 1-1 | 1-10 | 53.5 | 1.15 | 8.5 | 1 |
| Comp. Ex. 1-2 | 1-11 | 55.8 | 1.38 | 7.2 | 2 |
| Comp. Ex. 1-3 | 1-12 | 51.9 | 1.21 | 10.3 | 1 |
| Comp. Ex. 1-4 | 1-13 | 52.3 | 1.27 | 8.2 | 1 |
| Comp. Ex. 1-5 | 1-14 | 49.6 | 1.05 | 9.1 | 1 |
| Comp. Ex. 1-6 | 1-15 | 51.2 | 1.11 | 7.5 | 1 |
| Comp. Ex. 1-7 | 1-16 | 52.8 | 1.09 | 9.2 | 1 |
| Comp. Ex. 1-8 | 1-17 | 53.8 | 1.25 | 7.1 | 1 |
| Comp. Ex. 1-9 | 1-18 | 53.8 | 1.25 | 7.1 | 1 |
| Ex. 2-1 | 2-1 | 59.1 | 1.41 | 3.5 | 3 |
| Comp. Ex. 2-1 | 2-2 | 52.3 | 1.11 | 5.9 | 1 |

The results of Table 2-2 show that the toners prepared in Examples 1-1 to 2-1 offered high saturation, high coloring ability, and small color differences.

In contrast, the toners prepared in Comparative Examples 1-1 to 2-1 produce inferior color characteristics due to poor pigment dispersibility.

The toner of the present invention has excellent spectral reflection characteristics for color reproduction, has brilliant cyan color, is not harmful to the environment and human body, has a high coloring ability due to high pigment dispersibility in binder resin, and has high transparency. Thus, it is suitably used as a toner for full-color image formation. The developer, toner container, process cartridge, image forming apparatus, image forming method of the present invention that use the toner of the present invention are suitably used for high-quality electrophotographic image formation.

What is claimed is:

1. A toner comprising:
a toner material that contains at least a binder resin, a pigment, and a pigment dispersant,
wherein the pigment dispersant has an acid value of 20 mgKOH/g to 50 mgKOH/g and an amine value of 1 mgKOH/g to 50 mgKOH/g, and
wherein the pigment contains at least aluminum phthalocyanine.

2. The toner according to claim 1, wherein the pigment dispersant contains at least one of a polyester-based pigment dispersant, an acrylic pigment dispersant, and a polyurethane-based pigment dispersant.

3. The toner according to claim 1, wherein the pigment dispersant has a melting point of 20° C. to 80° C.

4. The toner according to claim 1, wherein the amount of the pigment dispersant is 1 part by mass to 100 parts by mass per 100 parts by mass of the pigment.

5. The toner according to claim 1, wherein the pigment further contains copper phthalocyanine, and the mass ratio of the copper phthalocyanine to the aluminum phthalocyanine is 40:60 to 90:10.

6. The toner according to claim 1, wherein the toner material further contains a wax.

7. The toner according to claim 1, wherein the toner material further contains a binder resin precursor and a wax.

8. The toner according to claim 1, wherein the toner is produced by a method which comprises:
dispersing or emulsifying in an aqueous medium an oil phase containing the toner material, to produce particles; and
aggregating the particles.

9. The toner according to claim 1, wherein the toner is produced by a method which comprises:
adding in an aqueous medium a dispersion liquid and an oil phase, the dispersion liquid containing a binder resin precursor composed of a modified polyester resin, the oil phase containing a fine particle dispersant;
dissolving a compound that is crosslinkable with the binder resin precursor;
dispersing the oil phase in the aqueous medium to prepare an emulsified dispersion liquid; and
allowing the binder resin precursor to undergo crosslinking reaction or extension reaction in the emulsified dispersion liquid.

10. The toner according to claim 5, wherein the copper phthalocyanine and aluminum phthalocyanine are mixed together by solvent salt milling.

11. The toner according to claim 5, wherein the toner is produced by dry-mixing the toner material followed by melt-kneading.

12. The toner according to claim 11, wherein in the toner material the copper phthalocyanine and aluminum phthalocyanine are mixed together in the form of powder.

13. A developer comprising:
a toner which comprises a toner material that contains at least a binder resin, a pigment, and a pigment dispersant, wherein the pigment dispersant has an acid value of 20 mgKOH/g to 50 mgKOH/g and an amine value of 1 mgKOH/g to 50 mgKOH/g, and wherein the pigment contains at least aluminum phthalocyanine.

14. An image forming method comprising:
forming a latent electrostatic image on a latent electrostatic image bearing member;
developing the latent electrostatic image with a toner to form a visible image;
transferring the visible image to a recording medium; and
fixing the image to the recording medium,
wherein the toner comprises a toner material that contains at least a binder resin, a pigment, and a pigment dispersant, wherein the pigment dispersant has an acid value of 20 mgKOH/g to 50 mgKOH/g and an amine value of 1 mgKOH/g to 50 mgKOH/g, and wherein the pigment contains at least aluminum phthalocyanine.
